(19) United States
(12) Patent Application Publication
(10) Pub. No.: US 2023/0052960 A1
(43) Pub. Date: Feb. 16, 2023

(54) Customizable Extended Reality Patient Simulator and Method Thereof for Healthcare Education

(71) Applicant: Ves, LLC, Wilmington, OH (US)

(72) Inventors: Steven Karl Westhoff, Wilmington, OH (US); Nathanael Alan Anderson, Wilmington, OH (US); Serigne Saalihou Mbacké Ndiaye, Dakar (SN)

(73) Assignee: Ves, LLC, Wilmington, OH (US)

(21) Appl. No.: 17/796,798

(22) PCT Filed: Jan. 29, 2021
(86) PCT No.: PCT/US2021/015727

§ 371 Date: Aug. 1, 2022

Related U.S. Application Data
(60) Provisional application No. 62/968,417, filed on Jan. 31, 2020.

(51) Int. Cl. G09B 23/28; G06T 19/00

(52) U.S. Cl. CPC G09B 23/28; G06T 19/006

(57) ABSTRACT

An educational system and method to provide various extended reality environments that are easily adaptable to a user's educational needs. The system includes a controller, a display, one or more sensors, a feedback unit and a rapid case creation tool. The rapid case creation tool is formed on the display to provide a graphical representation of at least a portion of the executable program elements to the user for manipulation in order to create and customize logic for a particular case or related learning, training or educational experience. In one form, the rapid case creation tool includes a case data module and a case logic module cooperative with one another such that upon manipulation by the user of at least a portion of the graphical representation of the executable program elements, the system performs at least one of creation, modification and operation of an extended reality patient case.

This application claims priority to U.S. Provisional Application 62/968,417 that was filed on Jan. 31, 2020.

The present disclosure relates generally to healthcare education technologies, and more particularly to a customizable extended reality patient simulator and method for use in healthcare education and training.

### BACKGROUND

Virtual reality (VR) and its variants provide immersive user simulation experiences that appear to a user to place him or her into a virtual environment that supersedes the real-world environment, thereby helping to create a suspension of disbelief and convincing the user's brain to perceive the experience as real, irrespective of the nature of the environment that is being simulated. Likewise, augmented reality (AR) provides computer-generated information that may be superimposed on a view being portrayed within a user's physical environment in order to provide contextually relevant information to the user. Furthermore, mixed reality (MR)—much like AR—presents the image information as an augmentation to the user, while additionally integrating any virtual content in a contextually meaningful way. Lastly, when VR, AR or MR are combined with sensor-based human-machine interactive systems to include one or more of closed-loop control, data-based machine learning or related software-based analytics, they may be subsumed under a larger class known as extended reality (XR) or cross reality to present to the user the fullest of the immersion experiences. Within the present disclosure, the acronym XR will be used, with the understanding that the device and methods disclosed herein may be equally applicable to allow information to flow between one or more of the particular VR, AR and MR variants, and that any distinctions or particular applicability of a particular one of which will be apparent from the context.

The use of spatial computing to take a user's physical body movements as commands or input into an interactive digital operating system such that a perceived three-dimensional physical space created by the operating system provides audio, visual, brain wave and haptic-based feedback to such user has numerous applications, particularly as a way to train a user in a particular form of immersive environment, including those for gaming, military, police and tactical, medical or other scenarios. Although these existing systems are suitable for their intended purposes, they lack the functionality to adapt a virtual environment rapidly and easily in response to particular healthcare educational user needs.

### SUMMARY

According to one aspect of the disclosure, a customizable XR patient simulator system includes a controller, numerous sensors, a display, a feedback unit and a rapid case creation tool that is formed on the display to provide a graphical representation of at least a portion of program instructions in the form of executable program elements to the user. The rapid case creation tool includes a case data module and a case logic module that are cooperative with one another such that upon manipulation by the user of one or more graphical representations of the executable program elements from each of the case logic module and the case data module, the system performs at least one of: creation of an extended reality patient case, modification of the extended reality patient case and operation of the extended reality patient case.

According to another aspect of the disclosure, a method of customizing an XR patient for use in an XR environment for healthcare education includes operating a customizable XR patient simulator system. In one form, the method includes one or more of the steps set forth in FIG. 13 and described in more detail hereinafter.

According to another aspect of the present disclosure, a method of customizing an XR patient for use in an XR environment for healthcare education is disclosed. The method includes presenting, on a display, a rapid case creation tool comprising a graphical representation of executable program elements. Thus, upon receipt of input from a user to select and graphically manipulate the graphical representation, case logic is formed on the display. Such case logic includes selected ones of the graphical representation that can be manipulated in order to instruct a system upon which the XR environment is presented to perform one or more of creation, modification and operation of an XR patient case. In one form, the case logic is displayed as a plurality of interconnected and editable nodes on the display, where such nodes may be made up of actions, checks, effects and effect chains. Likewise, the method may include performing one or more of the steps of the previous aspect.

### BRIEF DESCRIPTION OF THE DRAWINGS

Reference is now made to the following descriptions taken in conjunction with the accompanying drawings, in which:

FIG. 1 shows in block diagram form a system configured to perform operations in accordance with embodiments of the disclosure;

FIG. 2A depicts a simulation showing a patient within an XR environment and whose modifiable heart and lung sounds can be listened to with a virtual stethoscope using the system of FIG. 1;

FIG. 2B depicts a simulation showing a list of questions a user can ask the patient of FIG. 2A, as well as possible actions that a patient may be asked to take;

FIG. 3 depicts a case data module that makes up a part of a rapid case creation tool that is used to customize the system of FIG. 1;

FIG. 4 depicts a state sub-module that makes up a part of the case data module of FIG. 3;

FIG. 5 depicts an action sub-module that makes up a part of the case data module of FIG. 3;

FIG. 6 depicts a case logic module that makes up a part of a rapid case creation tool that is used to customize the system of FIG. 1;

FIG. 7 depicts a screenshot of the rapid case creation tool implemented as a graphical user interface in accordance with embodiments of the disclosure;

FIGS. 8 through 10 depict screenshots of a logic design window of the rapid case creation tool, as well as various visually depicted and editable case logic nodes;

FIG. 11 depicts application by a microprocessor-based controller of parameters read from the case data module for an effect node in accordance with embodiments of the disclosure;

FIG. 12 depicts a high-level flow of groups of activities used to set up a user training simulation on the system of FIG. 1;

FIG. 13 is a flow diagram illustrating example steps executed to implement one aspect of the present disclosure based on the high-level groups of activities of FIG. 12;

FIG. 14 depicts an optional overlay that may be used to enhance an educational or training exercise that is being conducted by the system of FIG. 1; and

FIG. 15 is a flow diagram illustrating example steps executed to implement case logic action, check and effects (ACE) of the case logic module of FIG. 6.

### DETAILED DESCRIPTION

The present disclosure is directed to devices, systems and methods that implement a technological solution for providing various XR scenarios that are easily adaptable to a user's educational needs in order to make the user's training experience more realistic. Within the present context, such user experience includes one or more of a location, environment, patient and additional factors which add to a user's immersion and retention.

Various features and advantageous details are explained more fully with reference to the non-limiting embodiments that are illustrated in the accompanying drawings and detailed in the following description. Descriptions of well-known materials, processing techniques, components, and equipment are omitted so as not to unnecessarily obscure the disclosure in detail. It should be understood, however, that the detailed description and the specific examples, while indicating embodiments of the disclosure, are given by way of illustration only, and not by way of limitation. Various substitutions, modifications, additions, and/or rearrangements within the spirit and/or scope of the underlying inventive concept will become apparent to those skilled in the art from this disclosure.

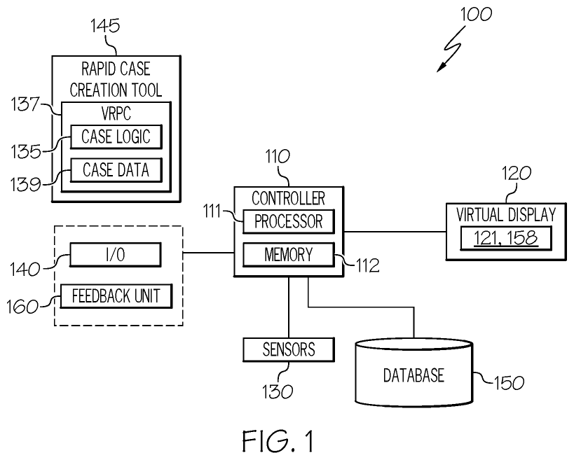

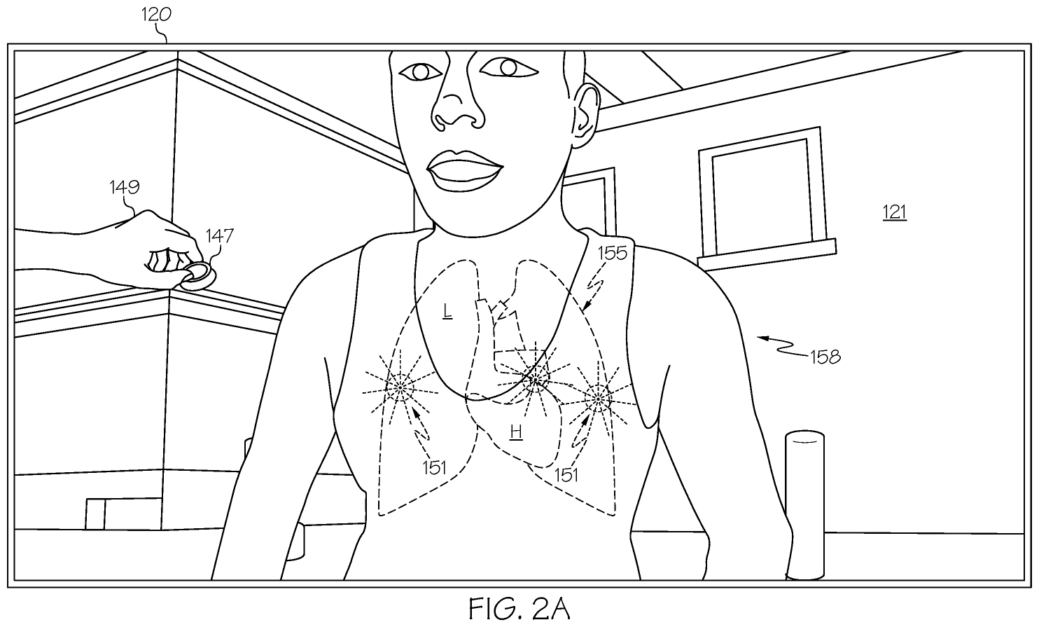

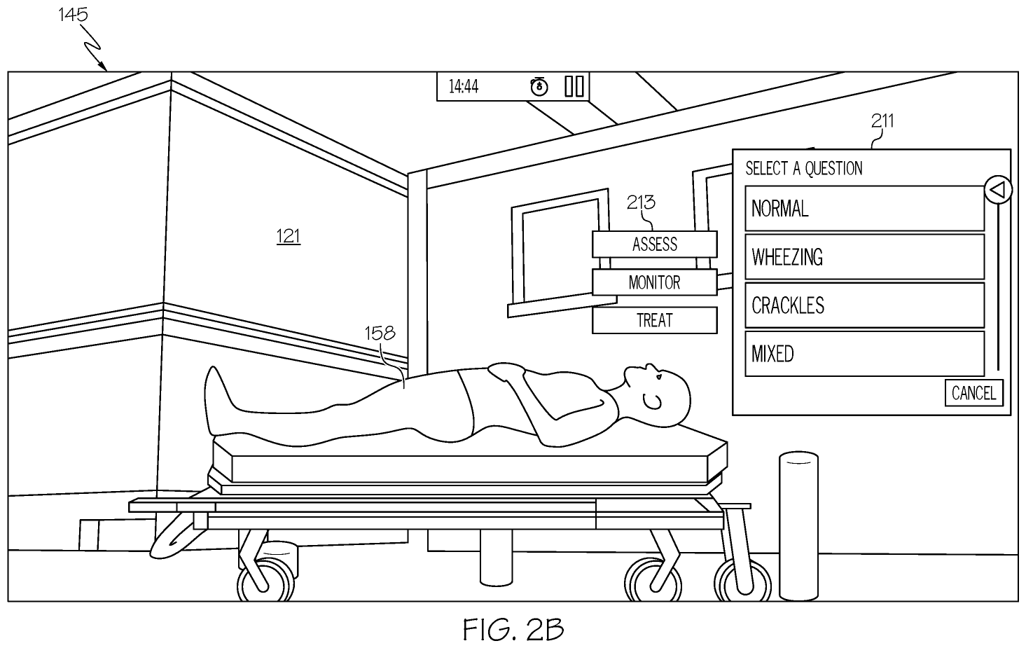

Referring first to FIGS. 1, 2A and 2B, a system 100 and a pair of customizable simulations with an XR patient 158 for healthcare-related education and training are shown. In one form, the system 100 may include controller 110, an XR display 120, sensors 130, input/output (I/O) unit 140, database 150 and assisted feedback unit 160 such that these (as well as other) components may cooperate with one another to provide the functionality discussed herein. For example, in one particular implementation, the system 100, under operation dictated by the controller 110 cooperatively operating with XR display 120, may generate an XR environment 121 in which the user is immersed to interact with the XR patient 158 that is in need of medical attention for the purpose of teaching, training or otherwise educating the user. In one form, the controller 110 may also be configured to receive sensor data from the sensors 130, to analyze and process the sensor data, to determine the user-patient interactions in the XR environment 121 based on such sensor data. It is noted that in one form, the XR display 120, the sensors 130 and the feedback unit 160 as well as controller 110 may be implemented in a single device, rather than separate devices. In another form, the controller 110, XR display 120, sensors 130 and feedback unit 160 may be implemented as separate units, communicatively coupled to one another via wired or wireless communications. Similarly, the feedback unit 160 and the I/O 140 may have common features (whether as part of a single unit or as separate units) such that information passing through the I/O 140 is shared by the feedback unit 160. Regardless of the nature of their interconnection, the controller 110, the XR display 120, the sensors 130 and the feedback unit 160 cooperate as part of a spatial computing interactive digital operating system that-along with the customizable features disclosed herein-allow the user to not only correlate body movements, actions, questions or the like as commands or input into the XR environment 121 to audio, visual, brain-computer interface and haptic response within such environment, but also to quickly and easily change one or more of the parameters that impact the correlation between the command and the response. In this way, the controller 110 is configured to operate upon executable program elements that are in the form of case-specific information pertaining to the XR environment 121, as well regulate case-specific interactions between a user of the system 100 and an XR patient 158.

A rapid case creation tool 145 enables on-screen creation and modification of fully dynamic configurations through various modules. In particular, an extended reality patient case (XRPC) may be accessed, built and customized by a user based upon data that is contained in a case data module 139 using case logic from a case logic module 135. With the rapid case creation tool 145, a user may quickly (typically, within minutes) create or customize the case logic for a case that describes a scenario of one or more simulated (that is to say, XR) patients 158 and that can be played immediately thereafter in an XR environment 121 or (if desired) on a web browser. As such, a customized training scenario for an XRPC may be quickly and easily created, modified or operated on. In one form, the creation or modification of an XRPC may be performed by a teacher, instructor or related educator for the purpose of training students, while the operation of the XRPC may be performed by a trainee, student or other individual whose performance is being evaluated. By presenting a customized training scenario, the system 100 determines how run-time interactions between a user and the XR patient 158 impacts at least one simulated medical condition of the XR patient 158.

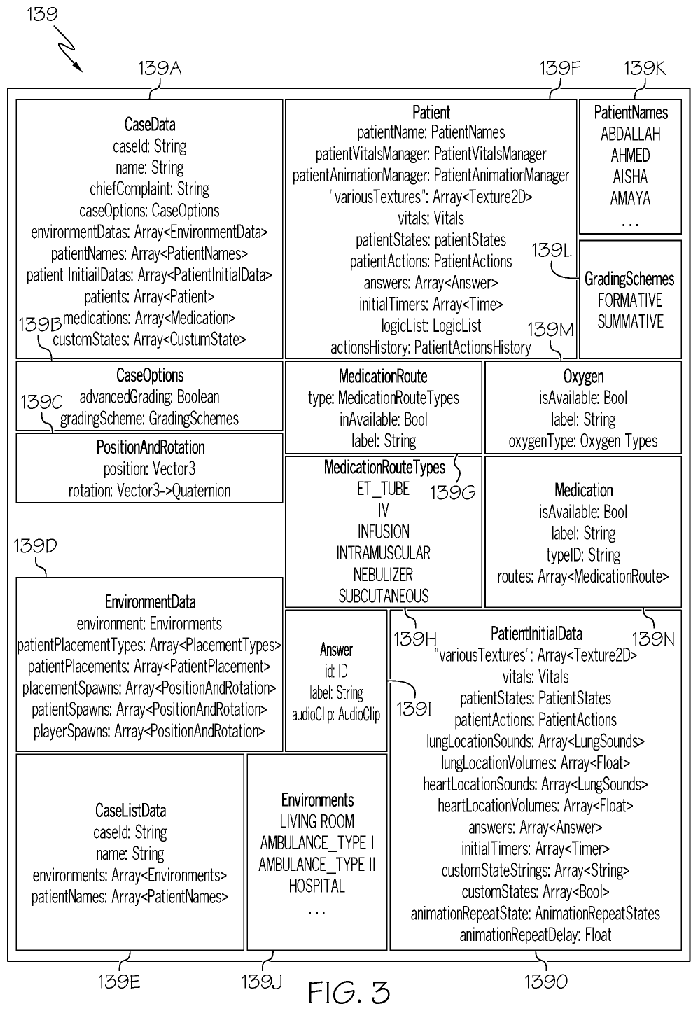

Various user-defined interconnected nodes (which will be described in more detail as follows) form part of the entered case logic in order to dictate how the actions of a trainee, student or related user impact the XR patient 158 where such impact may be any action that elicits a response from—or produces an effect upon—such patient, including changes in a health condition. In one form, the information generated within the rapid case creation tool 145 may be stored in the database 150 (which may be any of the same as, cooperative with or independent of, memory 112). In one form, the system 100 is configured such that some or all of the aforementioned components cooperate to present the rapid case creation tool 145 as a Graphical User Interface (GUI, which in one form may be more simply referred to as a user interface (UI)) with visual representations of executable program elements (that is to say, program instructions, data or the like that are part of a programming language and that have been reduced to machine code or related form for operation upon by the processor 111) such that a user may graphically select and manipulate such visual representations in order to form the case. In one form, such visual representation may exist as human-readable syntax corresponding to a code command, snippet, instruction or piece of data, while in other as an icon corresponding to such command, snippet, instruction or data. By including such GUI functionality, the feedback unit 160 acts as a translator for converting the various visual representations and related strings of command (such as those that will be discussed in more detail in conjunction FIGS. 3 through 6). For example, the feedback unit 160 may be made to be signally cooperative with the controller 110, the XR display 120 and one or more of the sensors 130 to present a customized XRPC that was created through the rapid case creation tool 145 to a sensory-based immersion of the user within the XR environment 121 as a visual (that is to say, graphical) representation of the underlying executable program elements. Likewise, during modification or operation of the XRPC, the feedback unit 160 cooperates with other portions of the system 100 in a comparable graphical manner.

Within the present disclosure, the term “case” is the description within the XRPC of a scenario that may be played out within the XR simulation on system 100. Further within the present disclosure, terms such as “case model” and “medical case training scenario” or the like are deemed to the equivalent of a case, particularly when placed within the context of a particular medical case training exercise as implemented by system 100. Within the present disclosure, the term “case logic” represents the customizable and dynamic set of rules that is stored in the case logic module 135, while the term “case data” represents various forms of data pertaining to (among others) one or more of the XR patient 158, the XR environment 121 and available actions for use by the user that is stored in the case data module 139.

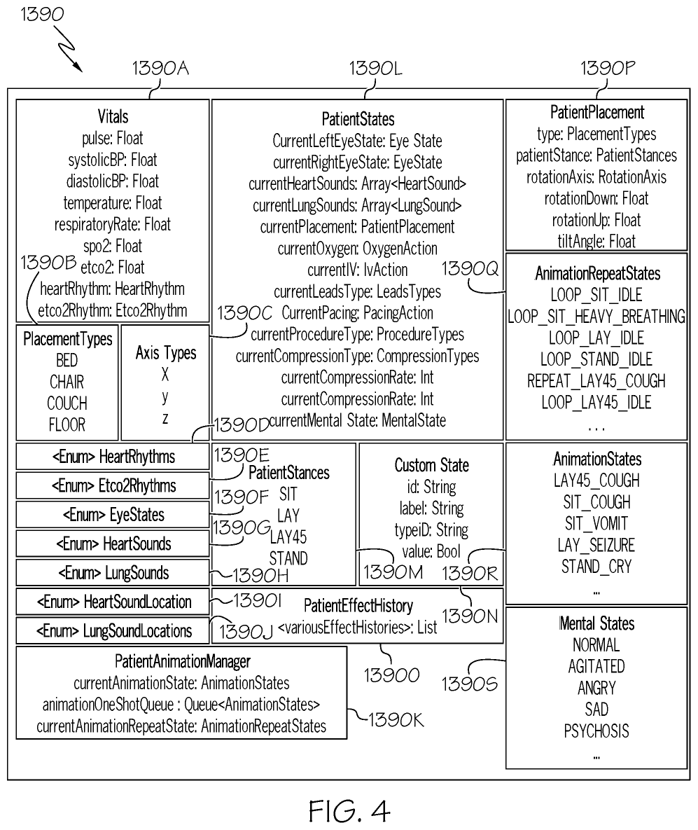

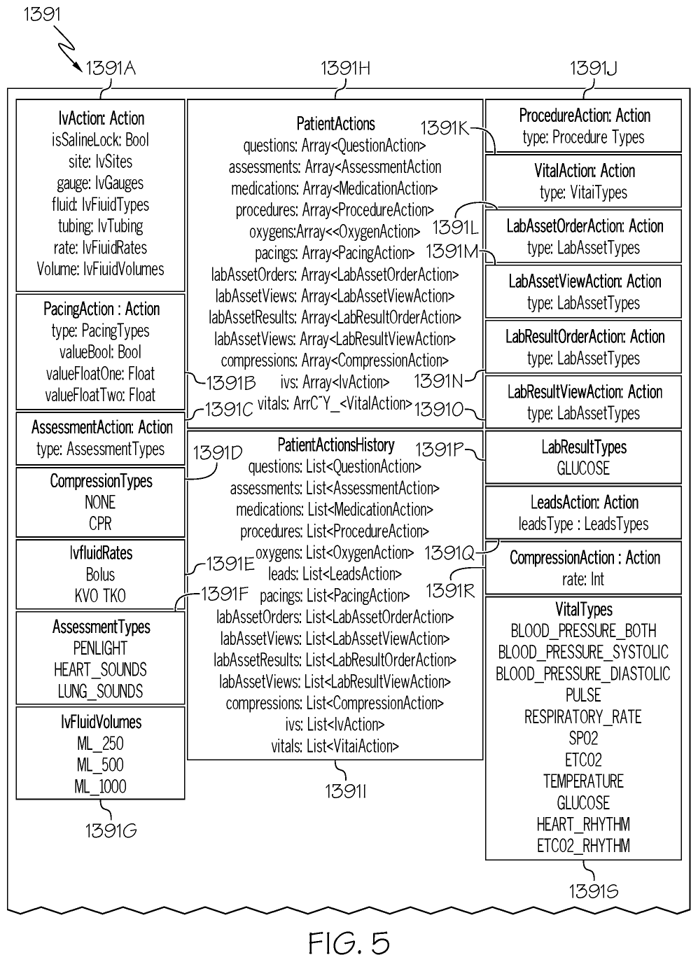

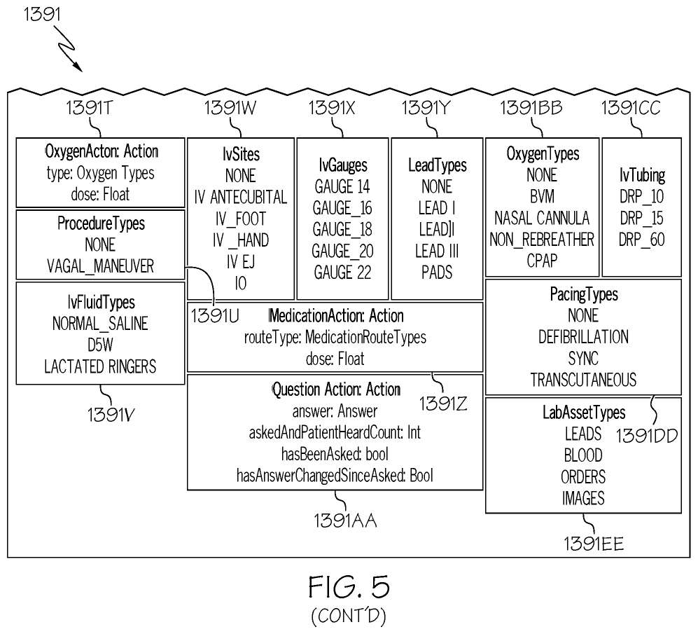

Multiple XR patients 158 may be presented as part of a given case, where an object of each XR patient 158 may be thought of as a snapshot of the patient's state, as well as available user actions (such as will be discussed in more detail in conjunction with an actions sub-module 1391) that may be taken on the XP patient 158 in order to transition from one state to another. Within the present disclosure, the term “snapshot” includes various information pertaining to the XR patient 158 at a given moment in time, while the term “state” that corresponds to the particulars (such as will be discussed in more detail in conjunction with a state sub-module 1390) of the XR patient 158 contained within the snapshot. In one form, such a construct can be thought of as allowing the XR patient 158 to be modeled with sequential behavior such as that depicted by a state machine. Both the state and actions submodules 1390, 1391 will be discussed in more detail in conjunction with FIGS. 4 and 5, respectively. Together, the case, the state, the case logic, the case data and the various user actions that produce the input necessary to transition from one state to another make up data elements that when combined within the system 100 by the rapid case creation tool 145 permit a simple, easily extendable and highly dynamic representation of a particular medical case training exercise. In the present context, the term “object” may be thought of as a data object. As such, the state of the XR patient 158 is whatever data elements the patient currently has. In that way, when a user takes an action, the values are acquired in the form of a snapshot of the data elements relevant to that action and in turn saves as a timestamped history of such action and values as the data object. Furthermore, this permits subsequent lookup and checking of those historical values in case logic checks or grading.

Referring with particularity to FIG. 1, in operation, the system 100 allows the presentation of the XR environment 121 with the XR patient 158 to a user through the XR display 120 to allow the user to be immersed into the XR environment 121, including the ability to customize the XR patient 158 through the rapid case creation tool 145 and its associated modules 135, 137 and 139. In one form, the XR display 120 may comprise a virtual reality device, an augmented reality device, a mixed reality device, a computer screen, a television screen, a projector, or any device configured to display a virtual representation within the XR environment 121 of the XR patient 158 or parts thereof as a virtual avatar for use in the training exercise or simulation discussed herein. In one form, the XR display 120 may be a headset, such as those commercially available from manufacturers such as Oculus, HTC, Valve or the like, as well as any other XR, VR, AR or MR display. In one form, the XR display 120 may be configured to facilitate and be responsive to user actions according to the entered logic from the case logic module 135. In this way, the XR environment 121 may be configured to facilitate virtual tasks to be performed by the user, including giving the user the ability to customize one or more features that are depicted within such environment. These virtual tasks may have associated actions in the real-world such that performing the virtual tasks may correspond to the user performing similar real-world actions.

In one form of operation, the XR environment 121 is rendered and presented by the controller 110 on the XR display 120 as a game simulation (or more particularly, a medical simulation or healthcare simulation) using a conventional virtual reality operation/presentation application, such as the Unity Virtual Reality application from Unity Technologies of San Francisco, Calif. The rapid case creation tool 145 is written in a conventional software language, such as C and its object-oriented variants C++ or C#, JavaScript or other known approaches, where cooperating objects are instantiated from classes based on abstraction, encapsulation, polymorphism and inheritance. By selecting from graphical menus within the case data model 139 or one of its sib-modules, the rapid case creation tool 145 can create a customizable XR environment 121 for the associated XRPC and output the resulting logic in a form (such as a scripting language format) that is executable by the system 100 in order to implement the XR environment 121 on the XR display 120. It is to be appreciated that other conventionally available VR, AR and MR applications and their associated scripting language, as well as other software programing languages, may also be used in order to implement the rapid case creation tool 145 on system 100.

Referring with particularity to FIGS. 2A and 2B, a pair of simulations are shown, one with the XR patient 158 in a sitting position (FIG. 2A) and the other with the XR patient 158 in a supine position (FIG. 2B). In one form, the XR patient 158 is in the form of a virtual avatar that may be configured by rapid case creation tool 145 for the XRPC to have physical attributes of a so-called “real world” patient. The XR patient 158 may be configured to present one or more medical conditions (such as trauma or related emergency medical needs) for a given medical case training scenario, as well as how to respond to user interactions according to the created or customized case logic. In addition, the XR patient 158 may be customized to include various attributes, such as body shape, skin color, height, weight, hair color, voice, accent, dialect, age, gender or the like in addition to presenting various medical conditions encountered by first responders such as emergency medical technicians (EMTs), police officers, nurses or other caregiving personnel. In some cases, the XR patient 158 that is associated with a particular XRPC is pre-defined as a patient type with a medical condition that is stored in and retrievable for use from the database 150. Any XR patient 158 that is created or pre-defined may be customized by the rapid case creation tool 145 for any particular educational need of the user. As with the creation and customization of the XR environment 121, the rapid case creation tool 145 can create and customize the XR patient 158 by selecting from graphical menus, only this time from one or both of the case data model 139 and the case logic module 135. For example, the XR patient 158 may be customized by its behavior, values or the like through the the rapid case creation tool 145. Also in a manner similar to the creation and customization of the XR environment 121, the rapid case creation tool 145 can output the case logic in a form (such as a scripting language format) that is executable by the system 100 in order to implement the case on the XR display 120. In particular, the output of the rapid case creation tool 145 involves storing the selected data values and customized logic into a database, which can then be retrieved in a data format such as JavaScript Object Notation (JSON). From there, it is converted into data objects or structure that the various parts of the system 100 may make use it.

As can be seen in FIG. 2A, certain vital signs—such as heart H and lung L sounds—of the XR patient 158 can be listened to by a user with a virtual stethoscope 147 that is shown being held in a user's virtual hand 149. In one form, the sounds and their respective volumes that are being acquired through the virtual stethoscope 147 are modifiable through the state sub-module 1390 that makes up a portion of the case data module 139 and that will be discussed in more detail in conjunction with FIG. 4. The volume also depends upon the proximity of the stethoscope to the body location as well as the blend of other body location sounds or proximities. The various lines depicted in XR patient 158 are a simulation of the “behind the scenes view” of the dynamic nature of the sounds, volumes and proximities, showing the highly customizable and dynamic nature of the experience. For example, a first group of lines 151 represent various body locations, each with its own modifiable sound or volume, while a second group of lines 153 represent full volume proximity locations of certain organs, where the volume tapers off the farther the stethoscope 147 is from the center of the relevant organ.

As will be discussed in further detail as follows, sensors 130 may collect sensor data from the user, and the sensor data may be provided to controller 110 to indicate that the user has interacted with the XR patient 158. For example, in various embodiments, the controller 110 may be configured to determine that the user has reached, or is reaching, for the XR patient 158 or a virtual object such as the stethoscope 147, based on the location of the user with respect to the XR patent 158 or such virtual object. In one particular implementation, the determination that the user has reached, or is reaching, for the XR patient 158 or virtual object may be based on the location of the user's virtual arm or hand 149 with respect to such patient or object. For example, in embodiments, an area of interactivity around the XR patient 158 or virtual object may be established. In other examples, the XR patient 158 or virtual object may be determined to be within a virtual area, referred to herein as a virtual target area. In some aspects, this virtual target area may refer to a three-dimensional space, area, or threshold within the XR environment 121 within which the virtual object may be located. In these embodiments, reaching the virtual object may require reaching at least the virtual target area.

In one form, the user-patient interaction between the user and the XR patient 158 within the XR environment 121 may include having the controller 110 determine that the user is reaching for or touching a particular location on the XR patient 158 by determining that the user's gaze within the XR environment 121 is placed upon the particular location of the XR patient 158. In this case, when the user is virtually looking at the XR patient 158, the controller 110 may determine that a movement of the user's hand 149 or head (not shown), in combination with the user's gaze, toward a particular area of the XR patient 158, indicates that the user may be virtually touching the XR patient 158 in the particular place. For example, the user may desire to place the virtual stethoscope 147 at a particular location on the XR patient 158 in order to detect sound differences presented at that location, as well as at other locations on the XR patient 158. In one form, the touching may be done directly through the virtual hand 149, while in another form done indirectly through the virtual stethoscope 147 or a related virtual instrument. Such other instruments may include one or more medical devices such as, and not limited thereto, a needle, a tongue depressor or a penlight or related devices for inspecting the mouth, throat, ears, eyes or the like, all of which are within the scope of the present disclosure.

As can be seen in FIG. 2B, the user may instruct the XR patient 158 to lie down on a stretcher such that the XR environment 121 would show the XR patient 158 moving from the upright, sitting position of FIG. 2A toward the supine position of FIG. 2B. In addition to showing the XR patient 158 lying down on a cot, images depicting a partial list of questions 211 and possible user action (or actions) 213 may also be made to pop up on the display 120. As with the previously-discussed sounds, the list of questions 211 is modifiable, as are answers the XR patient 158 may provide in response to such questions. Equally significant is that any of the user actions 213 taken are also modifiable such that the effects of asking one of the questions from the list of questions 211 and related user action 213 can have a dynamic impact upon the simulation. Thus, depending upon the current state of the XR patient 158 and the user's history of actions 213 within the simulation, different outcomes for the condition of the XR patient 158 may ensue. FIGS. 4 and 5, along with the accompanying description, provide a more detailed discussion of the questions 211 and actions 213.

Referring again to FIG. 2A, the controller 110 may be configured to adapt the XR environment 121 in response to the user's interactions with the XR patient 158. Following the example previously discussed, a game simulation of an XRPC is shown in the XR environment 121 so that the user may listen for—among other things—heart H and lung L sounds through the virtual stethoscope 147. As previously discussed, such sounds and the sound volumes are modifiable, while the volume also depends upon the proximity of the stethoscope 147 to the first group of lines 151 or the second group of lines 153 that correspond to certain body locations of the XR patient 158. For example, as the user places the stethoscope 147 at a first location on the chest of the XR patient 158 by a virtual hand 149, a first heartbeat sound recording according to the case logic module 135 is output, such as through one or more of the feedback unit 160, speakers that are integral with the XR display 120 or other sensory-based devices. Accordingly, when the user moves or places the virtual stethoscope 147 at or adjacent the second group of lines 153 on the chest of the XR patient 158, a second heartbeat sound recording according to the case logic module 135 is output. The controller 110 may also be configured to output both sound recordings, as well as a blend of the sound recordings with different intensities based on the location of the virtual stethoscope 147 between the various groups (or at other locations) on the chest of the XR patient 158 in order to provide a more realistic interaction. The same functionality may likewise be provided for the placements of the virtual stethoscope 147 at other locations on the body of the XR patient 158, such as the back, arms, legs, neck or the like, with additional sound recordings being played to the user as well as different responses with the placement or location of virtual object. In this way, upon the virtual insertion of one or more needles into the XR patient 158, as well as a beam of light from a pen light placed into the mouth, eyes, ears or the like of the XR patient 158 may be recorded. Each such user interactions with the XR patient 158 may have an associated response shown by the XR patient 158.

User data that may be captured by the sensors 130 includes conformation, location, movement, speed, velocity, tilt, position, force, acceleration or the like in the XR environment 121, as well as locations on the XR patient 158 based on the location, movement or position of the user in the real world. In some aspects, the sensors 130 may be configured to be placed upon the user's body, such as on one or more arms, hands, legs, torso or the like. The captured sensor data may be related to a particular action 213 needed to be tracked for determining a reaction of the XR patent 158 in the XR environment 121. For example, the sensors 130 may be configured to take measurements with respect to the user's actual hand locations, including whether the hand has moved or may be moving, the speed of the movement, the extent or range of the movement, the location of the user's hand with respect to the XR environment 121 or the like. In this manner, the measurements captured by the sensors 130 may indicate whether the user's virtual hand 149 or a virtual object such as stethoscope 147 held in the user's virtual hand 149 is contacting the XR patient 158 and if so, where it is contacting the XR patient 158 with respect to the XR environment 121. This sensor data and information may be used to determine the status of the user's interaction with the XR patient 158 with respect to a particular response according to the case logic module 135. In other aspects, the sensors 130 may be configured to capture user data without being placed upon the user. For example, the sensors 130 may be mounted external to the user, such as in the form of motion detectors, microphones or the like that are placed around the real-world environment or mounted (such as on stands, other devices or the like) around the area where the user may be expected to move.

In one form, the sensors 130 may comprise a sensor array that may be made up of similar sensors configured to capture a particular type of data. For example, the sensors 130 in the sensor array may be similarly configured to capture acceleration information. In other aspects, the sensors 130 in the sensor array may be configured to capture different types of data; in such a configuration, one sensor 130 in the sensor array may be configured to capture acceleration information, while another sensor 130 may be configured to capture location information. Likewise, another sensor 130 may be configured to capture verbal inquires and responses of the user. In one form, the sensor data that is captured by the sensors 130 may be provided to controller 110 for processing the acquired data, as well as to determine if any modifications need to be made to the XR environment 121, as previously discussed. Lastly, motors, haptic devices, microphones, speakers or the like that are responsive to the feedback unit 160 may be cooperative with (or form a part of) some of the sensors 130 in order to correlate movement or other dynamic-based ones of the interactions between the user and one or both of the XR environment 121 and the XR patient 158. In this way, the controller 110, the XR display 120, the sensors 130 and the feedback unit 160 cooperate to provide the user with the necessary audio, visual, brain-computer interface and haptic responses within the XR environment. Thus, generated feedback and the corresponding cooperation among at least these components helps to correlate any interaction between the user and the XR environment 121 and the XR patient 158 that is presented therein to the user's sensory-based immersion within such environment.

In some aspects, not all of the data that is acquired by the sensors 130 may be used to modify the XR environment 121. For example, some of the data may be used to determine whether and how the user is progressing in achieving the stated training objectives of the XRPC. This progress determination may be made by comparing sensor data related to a particular action metric. For example, sensor data associated with particular actions 213 of the user may be stored in the database 150 for a first educational session of the XRPC. During a subsequent educational session of the XRPC, sensor data associated with the particular actions 213 of the user may be collected and compared with the sensor data collected during the first educational session to determine if there has been an improvement with respect to accomplishing the stated training objectives of the XRPC. A progress report may be made available to the user, such as through I/O unit 140.

In one form, the I/O unit 140 may include a display, keyboard mouse or related device, and may be configured to display a GUI, such as the rapid case creation tool 145, structured to facilitate visual scripting-based input and output operations in accordance with aspects of the present disclosure. I/O unit 140 may be configured to accept input from one or more users, including input for the creation of, selection of, or editing of the various modules (and sub-modules) discussed herein through the rapid case creation tool 145 that in one form may be saved to and retrieved from the database 150. In one form, the I/O unit 140 may be configured to provide output which may present, display or reproduce the XR patient 158 within the XR environment 121. In these cases, an instructor may be able to monitor what the user is perceiving in the XR environment 121.

In one form, the database 150 (a common example of which is the open-source native multi-model database system developed by ArangoDB GmbH) may use a JSON-based storage format to facilitate storage operations. In one form, the database 150 may be running as a case application programming interface (API, that is to say, “app”) server in which to provide the JSON file for the associated case data over a network. In addition to data and logic associated with the XRPC and its associated case logic and data modules 135, 139, the database 150 may be configured to store previously measured sensor data, user actions 213, user profile information or the like. In some aspects, the database 150 maybe integrated into the memory 112, or may be provided as a separate module. In yet other aspects, the database 150 may be a single database, or may be a distributed database implemented over a plurality of database modules. Relatedly, the database 150 may be configured to store information for a plurality of XR patients 158, as well as for one or more uniquely-identifiable users and various training and learning operations, exercises, scenarios or the like.

Feedback unit 160 may be communicatively coupled to the controller 110 to receive a feedback signal therefrom based on a virtual action 213 being performed in the XR environment 121. In this manner, feedback unit 160 provides a real-world response, such as sounds, vocal responses and tactical responses in order to assist the user in the performance of the XRPC. The following sections describe the data model use for representing the XRPC in the game simulation.

Referring next to FIGS. 3 through 6, a case may be set up in the XRPC using the case logic module 135 and the customizable data parameters from the case data module 139. As will be discussed in conjunction with these figures, upon loading the case into the system 100, the data that corresponds to each XR patient 158 represents the initial snapshot of that patient, whereas while the case progresses, the snapshot goes through modifications driven by user actions and case logic.

Referring with particularity to FIG. 3, an example of customizable data parameters within the case data module 139 is shown. In particular, such parameters include case data 139A, case options 139B, position and rotation 139C, environment data 139D, case list data 139E, patient data 139F, medication route 139G, medication route types 139H, answers 1391, environments 139J, patient names 139K, grading schemes 139L oxygen 139M, medication 139N and patient initial data 139O. The case data 139A is used to identify the high level setup of the case, such as which patient character, environment setting, chief medical complaint and available medications, as well as hold reference to various option sub-objects. The case options 139B contain general options which may include grading preferences and other future preference options. The position and rotation 139C is a utility object that has the x, y, z position in the Cartesian world space of the XR display 120, as well as the x, y, z, w facing rotation. The environment data 139D holds information about the environment setting, such as an identifier name, what objects are in the environment that the XR patient 158 can be placed upon (such as a bed, floor or the like), and the spawn locations for the user, patient and the placements. The case list data 139E contains the name of a case, a patient and the environments, and are available in a list so the currently available cases can be displayed to the user menu for case selection. The patient data 139F is used to store everything about the XR patient 158, such as medical values, states, animation, lab images, case logic actions, checks, effects, timers, question answers and anything else directly related to the XR patient 158. The medication route 139G holds the information about what routes a medication could be available by the user to deliver simulated medicine to the XR patient 158, whether it actually is available, as well as a display name. The medication route types 139H enumerates the specific routes a medication could be available for use. The answers 1391 are the verbal or text displayed patient answers to questions asked of the XR patient 158. The environments 139J enumerates the specific environment names. The patient names 139K enumerates the specific patient names. The grading scheme data 139L may be used to indicate whether the testing or training being performed involves a formative or summative assessment. The oxygen 139M contains the name, display name and availability of an oxygen delivery type. The medication 139N contains the name, display name, availability and a list of its potential medication routes. The patient initial data 139O stores the values of XR patient 158 and states for the start of a case, which is applied—or reapplied—to the XR patient 158 at the start of each run of the case.

Referring with particularity to FIG. 4, the state sub-module 1390 of the case data module 139 is shown. As previously mentioned, the objects and their associated snapshot information from the case data module 139 corresponds to the state of the XR patient 158. Such states (some of which may be thought of as medical conditions) include a patient vitals state 1390A, a placement state 1390B (which corresponds to those things with which the XR patient 158 may interact, such as beds, chairs, floor or the like), an axis types state 1390C, a heart rhythms state 1390D, an end-tidal CO₂ (etCO₂) state 1390E, an eye state 1390F, a heart sounds state 1390G, a lung sounds state 1390H, a heart sound location state 1390I, a lung sound location state 1390J, a patient animation manager state 1390K, a patient state 1390L, a patient stances state 1390M, a custom state 1390N, a patient effect history state 1390O, a patient placement state 1390P, an animation repeat state 1390Q, an animation state 1390R and a mental state 1390S. The patient vitals state 1390A holds the medical vitals values for the XR patient 158. The placement types 1390B enumerates the placement names for any object the XR patient 158 could be placed upon. The axis types 1390C is a utility enumeration representing each axis of 3D space. The heart rhythms 1390D enumerates the types of cardiac rhythm waveforms, which are used to determine the electrocardiogram (ECG) shape displayed on the monitor. The etCO₂ rhythms 1390E enumerates the types of carbon dioxide exhalation rhythm waveforms, which are used to determine the etCO₂ shape displayed on the monitor. The eye states 1390F enumerate the amount of dilation an eye has, such as constricted, normal, and dilated. The heart sounds 1390G enumerate the types of cardiac malady audio clips that could be assigned for use on the chest of the XR patient 158. The lung sounds 1390H enumerate the types of respiratory malady audio clips that could be assigned for use on the chest of the XR patient 158. The heart sound locations 1390I enumerate the different spots on the chest located around where the heart can be heard through a stethoscope. The lung sound locations 1390J enumerate the different spots on the chest located around where the lungs or trachea can be heard through a stethoscope. The patient animation manager 1390K tracks the states of the animation system of the XR patient 158, which includes the active animation, any queued one shot animations, and repeating animations. The patient state 1390L is the container for every state associated with the XR patient 158, except for those stored directly on the XR patient 158 or in a manager, such as vitals or animation states respectively. The patient stances 1390M enumerate the physical orientation of the XR patient 158, such as sitting or laying, and is used in the patient animation manager 1390K. The custom state 1390N is a data object that stores user created logic switch information such as an identification number, a name, and current Boolean value. They are used to track states that are not associated with any particular aspect of the system 100, but rather defined and controlled completely by the user via the rapid case creation tool 145. The patient effect history 1390O keeps a list of historical case logic effect data for use in calculating precise values across clients over the network. Some are kept for the duration of the case, and some expire once past the potential network latency timeout maximum. The patient placement state 1390P keeps the information about the placement's available stances of the XR patient 158 and whether it has an elevated headrest or bed rail, if applicable to the placement. The animation repeat states 1390Q enumerate the various repeating animations that a patient character could play, which are tracked in the patient animation manager. The animation states 1390R enumerate the various non-repeating animations that a patient character could play, which are tracked in the patient animation manager 1390K. The mental state 1390S enumerate the various level of consciousness and psychological conditions that the XR patient 158 could have.

Referring with particularity to FIG. 5, the action sub-module 1391 of the case data module 139 is shown. Actions included within this sub-module may include intravenous (IV) action 1391A, pacing action 1391B, assessment action 1391C, compression types 1391D, IV fluid rates 1391E, assessment types 1391F, IV fluid volumes 1391G, patient actions 1391H, patient action history 13911, procedure action 1391J, vital action 1391K, lab asset order action 1391L, lab asset view action 1391M, lab result order action 1391N, lab result view action 1391O, lab result type action 1391P, leads action 1391Q, compression action 1391R, vital types action 1391S, oxygen action 1391T, procedure types 1391U, IV fluid types 1391V, IV sites 1391W, IV gauges 1391X, lead types 1391Y, medication action 1391Z, question action 1391AA, oxygen types 1391BB, IV tubing 1391CC, pacing types 1391DD and lab asset types 1391EE. As previously discussed, some of the actions correspond to those inputs (such as user input) that can cause the particulars of the XR patient 158 to transition from one state to another. The IV action 1391A is the case logic trigger for when a user inserts a needle into the XR patient 158. The pacing action 1391B is the case logic trigger for when a user starts cardiac pacing or defibrillation on the XR patient 158. The assessment action 1391C is the case logic trigger for when a user inspects the XR patient 158 via penlight for eyes or stethoscope for heart and lung sounds. It will be appreciated that these assessments are exemplary, and that other forms of assessment commonly associated with addressing patent medical conditions are within the scope of the present disclosure. The compression types 1391D enumerate the kinds of compressions a user may perform on a patient, such as cardio pulmonary resuscitation (CPR). The IV fluid rates 1391E enumerate the drip speed types of an IV that would typically be administered into a patient. The assessment types 1391F enumerate the kinds of assessments a user may perform to investigate a patient's condition. The IV fluid volumes 1391G enumerate the amount of fluid for an IV a user may administer to a patient. The patient actions 1391H contains the user selected case logic actions, which serve as the starting point for the case logic flow for the associated user action events. The patient action history 13911 contains the historical user and the XR patient 158 data for each user action on a copy of the associated patient action from the patient actions 1391H; in essence, it is a history of what the user did that triggered the case logic. The procedure action 1391J is the case logic trigger for when a user performs a procedure on the XR patient 158, or has the XR patient 158 perform a procedure such as a vagal maneuver. The vital action 1391K is the case logic trigger for when a user measures a vital of the XR patient 158, such as hooking the XR patient 158 up to the monitor to read a pulse. The lab asset order action 1391L is the case logic trigger for when a user enters a request for a radiological image of the XR patient 158 to be taken. The lab asset view action 1391M is the case logic trigger for when a user looks at a patient's radiological images for analysis. The lab result order action 1391N is the case logic trigger for when a user enters a request for the patient's fluids to be taken for analysis. The lab result view action 1391O is the case logic trigger for when a user looks at the result values of the fluid analysis. The lab result types 1391P enumerates the kinds of lab values available for analysis. The leads action 1391Q is the case logic trigger for when a user applies ECG wire leads onto the XR patient 158. The compression action 1391R is the case logic trigger for when a user starts compressions on the XR patient 158. The vital types 1391S enumerates the kinds of values associated with basic human vitality. The oxygen action 1391T is the case logic trigger for when a user administers oxygen to the XR patient 158. The procedure types 1391U enumerate the kinds of procedures that can be performed on or by the XR patient 158. The IV fluid types 1391V enumerate the kinds of fluid that can fill the IV bag. The IV sites 1391W enumerate the locations with which the IV can be inserted into the XR patient 158. The IV gauges 1391X enumerate the needle thickness and type, where both IV and intraosseus (IO) variants are included. The lead types 1391Y enumerate the number and arrangement of the wire leads connecting the XR patient 158 to a monitor. The medication action 1391Z is the case logic trigger for when a user administers a medication to the XR patient 158. The question action 1391AA is the case logic trigger for when a user asks a question of the XR patient 158. The oxygen types 1391BB enumerate the kinds of oxygen delivery mechanisms that could be used on the XR patient 158. The IV tubing 1391CC enumerate the kinds of plastic tubing thickness used to connect the IV bag with the IV needle. The pacing types 1391DD enumerate the kinds of pacing and defibrillation that could be administered to the XR patient 158. The lab asset types 1391EE enumerate the kinds of radiological images and other medical images that could be available for the XR patient 158.

When the XRPC is loaded and run, the associated data from the case data module 139 (as well as its sub-modules 1390 and 1391) is placed into a JSON file and transferred to the controller 110 for implementation. It is to be appreciated that although the case data module 139 and code implementation acting thereon may adhere to a JSON format, any other format may be used in order to serve a particular implementation (such as an extensible markup language (XML) format, a hypertext markup language (HTML) format or the like). One manner in which the JSON or related data interchange format may be transferred is through a web service, such that a public or private network entity may employ cloud-based computing or storage that is accessible through the internet or a related networks to a single client or a distributed set of clients. Such a web service may be made up of numerous data centers that in turn may include one or more actual or virtualized computer servers, storage devices, networking equipment or the like in order to implement and distribute the offered web services.

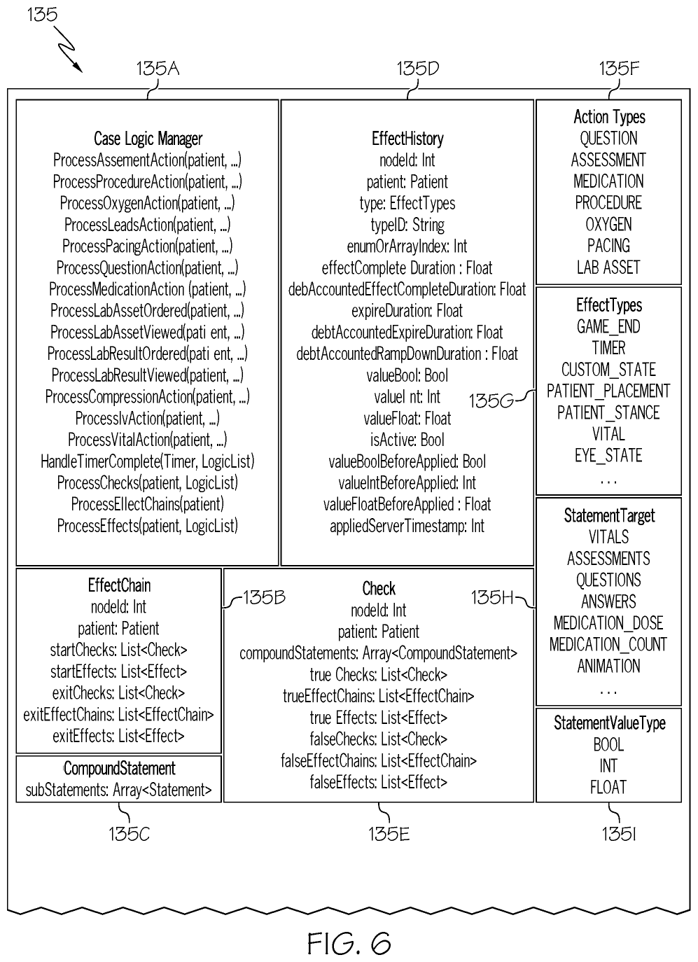

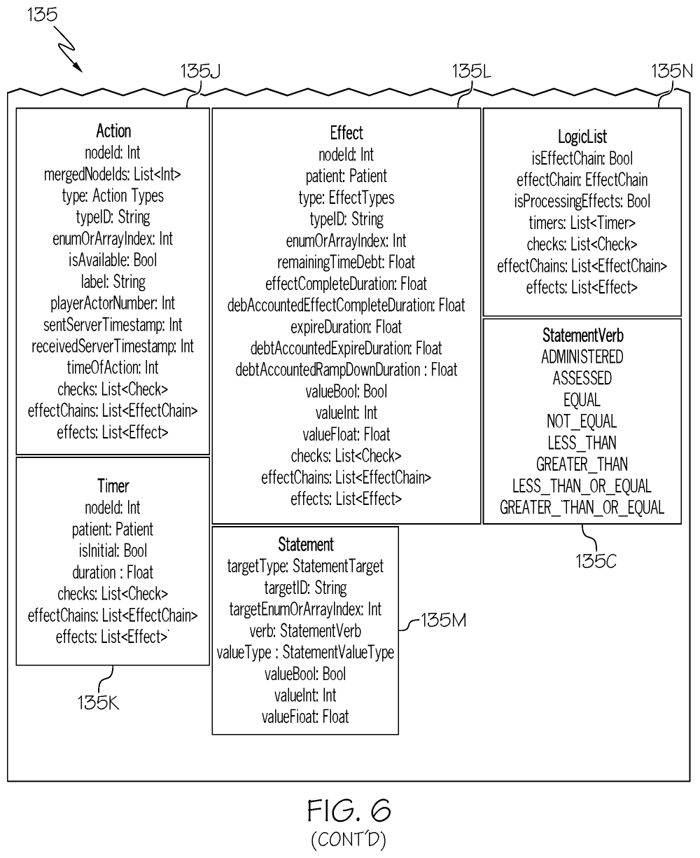

Referring with particularity to FIG. 6, as the XRPC progresses, the initial snapshot as provided by FIG. 4 goes through modifications driven by the user actions of FIG. 5 and the associated logic contained within the case logic module 135. As with the other module 139, at least some of the information pertaining to the case logic module 135 may be entered into the system 100 using I/O unit 140 and the rapid case creation tool 145, such as during creation by either the user or a case creator (such as an instructor or the like) for a particular educational exercise. In another form, the I/O unit 140 may be used to edit any previously-created case or case logic (which may be stored in memory 112 or the database 150) for a particular XRPC in order to perform customization. The case logic module 135 includes a case logic manager 135A, effect chain 135B, compound statement 135C, effect history 135D, check 135E, action types 135F, effect types 135G, statement target 135H, statement value type 135I, action 135J, timer 135K, effect 135L, statement 135M, logic list 135N and statement verb 135O.

Within the present context, the following naming formats are generally employed. The [name] is the variable or field name, whereas the right side of the colon is the data type (sometimes an individual type and sometimes a list or array of a type). The formula then may follow one of two general forms as follows: fieldName: FieldTypeName; and fieldName: Array<FieldTypeName>. When the data is just a word in all caps, then those are enum values, such as FORMATIVE and SUMMATIVE. One exemplary form could be for names of the XR patient 158, such as PatientNames{AMY, BEN, HAWTHORN, MILITARY_AMY, MILITARY_BEN, MILITARY_HAWTHORN} or Environments{DISPATCH, AMBULANCE_TYPE III, AMBULANCE_TYPE II, HOTEL_BATHROOM, BEDROOM, CLINIC, DINING_ROOM, ARCADE, EMERGENCY_ROOM, HOSPITAL, LIVING_ROOM, ALLEY_DAY, ALLEY_NIGHT, LAUNDROMAT, HOTEL_ROOM, SUBWAY_PLATFORM, SUBWAY_TRAIN, CITY_PARK_DAY, CITY_PARK_NIGHT, GYMNASIUM, STREET_CORNER, STREET_CORNER_NIGHT, URBAN_RIVERBED_DAY, URBAN_RIVERBED_NIGHT, PUBLIC_POOL, MILITARY_POOL, MILITARY_TENT, POOL_HAL}. Certain entries, such as the patient effect history 1390O (shown at the bottom of FIG. 4), is shown in compressed form, although it will be understood that they too comprise numerous filed, even though it is not an enumeration. By way of example, “<variousEffectHistories>” represents multiple fields, such as questionEffectHistories, vitalEffectHistories, or the like. One exemplary form could be for the history of effects upon the XR patient 158: PatientEffectHistory {customStateEffectHistories=Array<CustomStateEffectHistory>; patientPlacementEffectHistories=Array<PatientPlacementEffectHistory>; vitalsEffectHistories=Array<VitalsEffectHistory>; eyeStateEffectHistories=Array<EyeStateEffectHistory>; heartSoundEffectHistories=Array<HeartSoundEffectHistory>; lungSoundEffectHistories=Array<LungSoundEffectHistory>; questionEffectHistories=Array<QuestionEffectHistory>; answerEffectHistories=Array<AnswerEffectHistory>; animationOneShotEffectHistories=Array<AnimationOneShotEffectHistory>; animationRepeatEffectHistories=Array<AnimationRepeatEffectHistory>; oxygenEffectHistories=Array<OxygenEffectHistory>; labAssetEffectHistories=Array<LabAssetEffectHistory>; labModifyEffectHistories=Array<LabModifyEffectHistory>; labResultEffectHistoryContainers=Array<LabResultEffectHistoryContainer>; ivEffectHistories=Array<IvEffectHistory>; mentalStateEffectHistories=Array<MentalStateEffectHistory>; leadsEffectHistories=Array<LeadsEffectHistory>; pacingEffectHistories=Array<PacingEffectHistory>; procedureEffectHistories=Array<ProcedureEffectHistory>; compressionEffectHistories=Array<CompressionEffectHistory>; medicationEffectHistories=Array<MedicationEffectHistory>; medicationRouteEffectHistories=Array<MedicationRouteEffectHistory>; physicalAssessmentEffectHistories=Array<PhysicalAssessmentEffectHistory>; gradingEffectHistories=Array<GradingEffectHistory>; structuralMoulageEffectHistories=Array<StructuralMoulageEffectHistory>; moulageEffectHistories Array<MoulageEffectHistory>}. Likewise, another exemplary form can be for the initial data corresponding to the XR patient 158: PatientInitialData {bloodWorkLabMedialmageDatas Array<LabMedialmageData>; imageLabMedialmageDatas Array<LabMedialmageData>; twelveLeadLabMedialmageDatas Array<LabMedialmageData>; orderLabMedialmageDatas Array<LabMedialmageData>}. By way of another example, the entry for variousTextures that is part of the patient initial data 139O (shown in FIG. 3) is presently shown as a way to represent several different field names that function the same but have different names, such as bloodworkTextures or the like. It will be appreciated that these are merely shown to be explanatory rather than exhaustive, and that other enum or component values such as those depicted in FIGS. 3 through 6 may be structured similarly, and that all such values are deemed to be within the scope of the present disclosure.

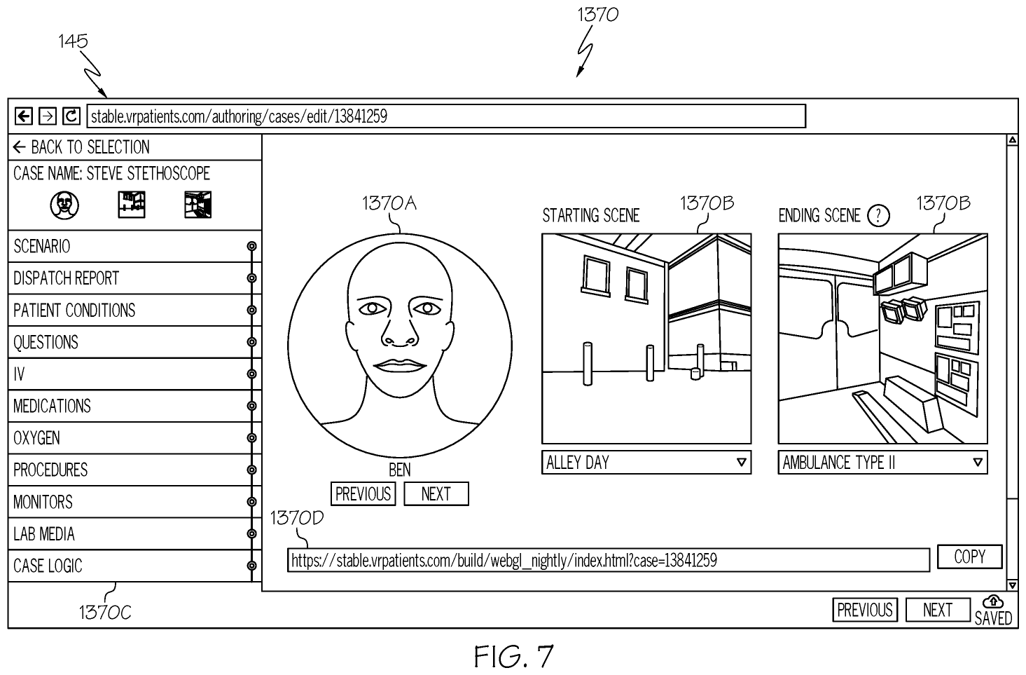

Referring next to FIGS. 7 through 10, the rapid case creation tool 145 allows the user to set up some or all of the case through a graphical element-based visual programming language (VPL) so that instead of textual statements, visual blocks and connectors may be used. In one form, a visual scripting editor (such as that associated with Visual Basic or the like) may be used for the case logic, while the data may be placed into an appropriate file (such as a JSON file) as previously discussed. In this way, the logic and data from the modules of FIGS. 3 through 6 and that are used to make a case match the user's specific needs may be introduced in the form of a visual representation of the underlying executable program elements, the visual representation made up of interconnected nodes between screen objects or related entities, thereby allowing the user to view, as well as quickly select and graphically manipulate, such representations. It will be appreciated that within the present context, the executable program elements may be in the form of commands, instructions, data, code snippets or other information that can be recognized and operated upon by one or more of the processor 111, memory 112 or other parts of the system 100 in order to create, modify or operate (that is to say, run) an XRPC in the manner disclosed herein. It will be further appreciated that in such circumstance where a particular training scenario XRPC is created, modified or ran, the information corresponding to the executable program elements becomes case-specific.

Referring with particularity to FIG. 7, one or more logic design windows 1370 may be displayed as part of a visual scripting system in order to facilitate the graphical setup of the case. As shown, the logic design window 1370 may be broken down into various sections including (among others) an avatar 1370A of the XR patient 158, various scenes 1370B, a case logic tab 1370C that in one form may include various hierarchical menus with which to gain access to the various states, actions and logic of the modules of FIGS. 3 through 6, and a case link 1370D (such as to a secure location within database 150) or the like.

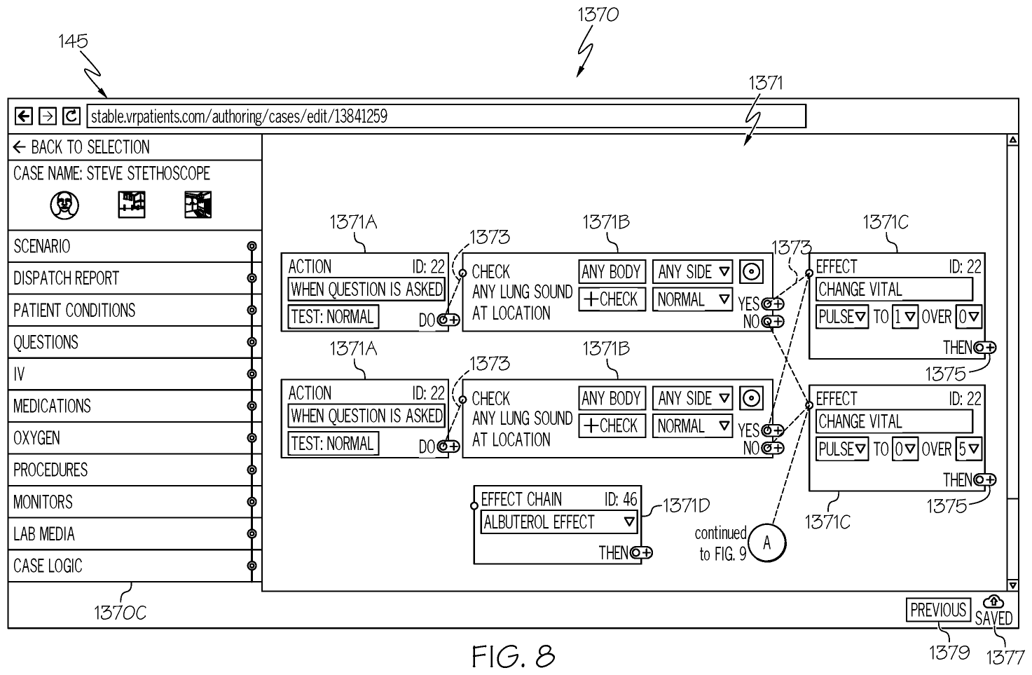

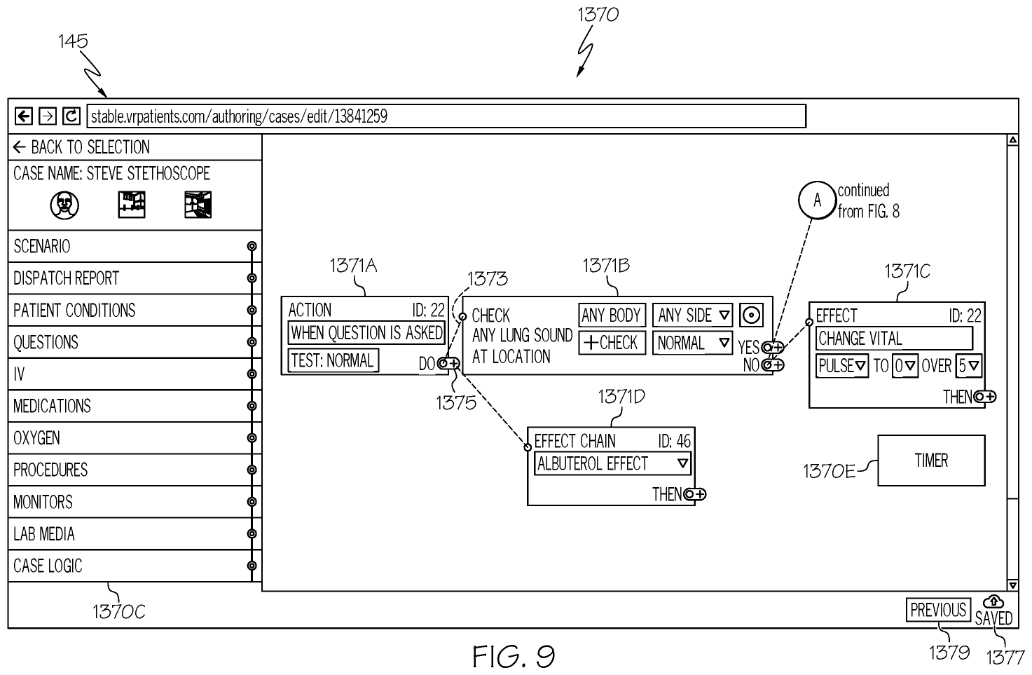

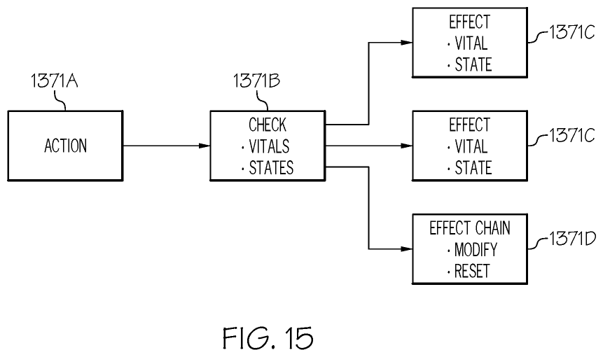

Referring with particularity to FIGS. 8 through 10 along with FIG. 15, logic design windows 1370 permit the user to create or edit smaller wrapped subsets or portions of the case, state, actions or logic through the graphical manipulation of various editable data nodes 1371 (or related program elements or entities that may correspond to a particular event) through relation-based interconnections 1373 in the form of arcs, arrows, lines or the like. In one form (and as will be discussed in greater detail in conjunction with FIG. 15), these data nodes 1371 may be further grouped according to certain functions into the smaller wrapped subsets. As shown, these data nodes include an action node 1371A, a check node 1371B, an effect node 1371C and an effect chain node 1371D that collectively form an action, check and effect (ACE) portion of the data elements. The data nodes 1371 may correspond to other objects, functions (and function calls), operations, variables, events or the like, depending on the need of a particular case. For example, a timer node 1371E (FIG. 9) may be made to be assignable to each effect node 1371C and effect chain node 1371D. In this way, the case logic allows the user's actions to be timed as a way to gauge his or her educational progress or competency. As with the case logic tab 1370C, hierarchical cascading allows for easy replication and modification of the particular action, check, effect or effect chain that is being depicted within the logic design window 1370. Together, the case logic and its smaller wrapped subsets allow the case logic module 135 to be set up as a dynamic logic entity such that a user (in the form of an instructor) can make an XRPC match a particular training or educational need. Although not shown, the case logic may be programmed by an instructor or other user to include random events such as a syncopal (fainting) episode as a way to gauge a student or trainee user's response.

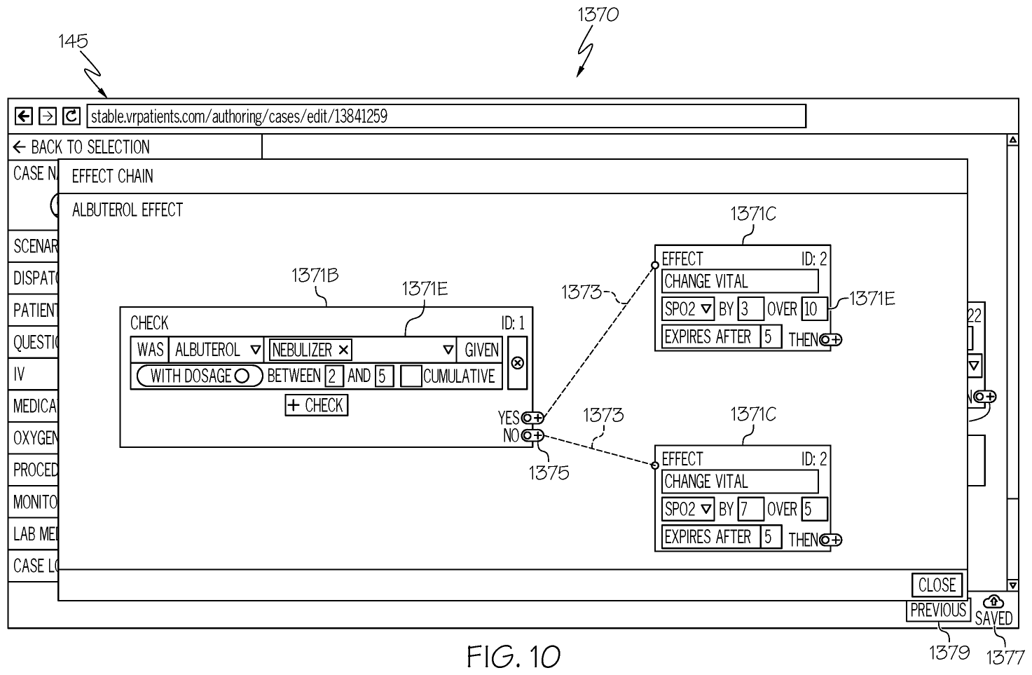

Within the present context, an effect node 1371C only changes one thing, whereas an effect chain node 1371D acts as a wrapper that has a whole subset of nodes within it, potentially changing many things. A blown up version of the internals of a representative effect chain node 1371D can be seen in FIG. 10. As noted, the effect chain nodes 1371D are a sub-collection of the ACE system logic, which in one form may be pre-defined by the manufacturer, which can then be copied and modified by an instructor in the rapid case creation tool 145. In another form, an instructor can also create his or her own effect chain nodes (not shown) as well. The effect chain nodes 1371D are added to the case logic module 135 in a manner similar to that of the effect node 1371C that was discussed in conjunction with FIGS. 7 through 10. For example, right clicking on the effect chain node 1371D (such as shown in FIGS. 8 and 9) will show available options in the rapid case creation tool 145, which may include, among others, an option to modify or reset. For example, by modifying, a nearly opaque overlay may be made to pop up to show and allow node-based editing, while resetting causes the relevant portion of the screen to be grayed out unless the effect chain node 1371D has been modified or overridden from within the case logic module 135, otherwise it resets the effect chain node 1371D. In one form, if an effect chain node 1371D has been modified, its coloring and text may be respectively shown brighter and bolder to provide readily-apparent indicia of such modification. As previously mentioned, an effect chain node 1371D may also be updated by the manufacturer; in such circumstance, the existing cases using that particular effect chain node 1371D will keep their version, but the instructor (or other designated so-called “super user”) will be notified the next time the case is opened in the rapid case creation tool 145 and any time the case logic tab 1370C of FIG. 7 is opened until the user clicks a decision “Ignore or Accept” for un-modified nodes and “Ignore or Ok” for modified nodes.

In operation, the action node 1371A defines the user actions (such as those depicted in the actions sub-module 1391 of FIG. 5 and includes (among other things) one or more of asking a question, giving medication, listening to heart H or lung L sounds, looking at an image or the like). In one form, the one or more of the action nodes 1371A may be the starting point of the case logic module 135 when running the game simulation for the XRPC. The check node 1371B is a generic “statement” comparison of a target to a value, which results in either a true or false condition, both of which are associated with their own follow-up lists, via the other interconnected data nodes 1371 that are depicted in FIG. 8. The effect node 1371C is a selected resulting impact that is read from the case data module 139 and applied or tracked according to an expireDuration parameter and effectCompleteDuration parameter (both shown in FIG. 6) that are also read from the case logic module 135 of the effect portion 135L and a copy stored in the effect history 135D.

As shown, the data nodes 1371 may be visually interconnected by a simple selection (such as through a mouse click) to present the interconnection line 1373 for actions that may involve two or more objects and that the user may drag to a desired interconnection point 1375. The case logic may be saved to the database 150 via simple save button 1377 as well as having an interconnection undone by a previous button 1379. It is to be appreciated that the data nodes 1371 when operatively joined via interconnections 1373 in the manner described provide a simple, easily extendable and highly dynamic representation of the XRPC and the associated case logic module 135. Significantly, this modification and customization may be made to take place without the need for a user or instructor to perform the more laborious task of performing modifications through the computer programming language that underlies and implements the rapid case creation tool 145 and the XR environment 121. As shown, the student, instructor or other interested user simply selects (such as through a mouse, keyboard or other I/O unit 140) which ACE system parameters are to take place through the placement of such data nodes 1371 in the logic design window 1370, along with the subsequent interconnection line 1373 placement, all as previously described. From there, the user may define one or more effects for any interconnected action via drop-down box selection of effects node 1371C, as well as timing for such an effect via an associated timer node 1371E. As such, the interconnection lines 1373 promote customization of portions of the case logic (such as the ACE portion) in that when placed between a pair of the data nodes 1371, the interconnection lines 1373 are providing a so-called logic bridge between the connected nodes 1371 to establish a truth function, conditional operation or related logical connection therebetween. In a similar way, performing a check with an action, as well as what effect chain should be followed as a result of the check, may be quickly set up. FIG. 10 shows an example of a cascading set of screens or canvases within a logic design window 1370. In particular, it depicts an effect chain corresponding to the virtual administering of the lung medication albuterol to the XR patient 158.

An example case logic in general (and check node branching logic as shown with particularity in FIG. 10) may be used to make tangible an abstraction, such as an effect chain for a drug administration action and the possible effects as defined by various nodes of a corresponding effect node. In particular, the steps associated with giving simulated adenosine to the XR patient 158 and its subsequent effect may be depicted. It will be appreciated that there are numerous other examples of drug administration or related actions that can be modeled by such node branching logic. In this way, common chains of logic for the user or instructor may be simplified during any creation or editing of the rapid case creation tool 145. As shown, such steps and associated logic can be made to depict the various data nodes 1371 corresponding to the virtual administering of the heart arrhythmia medication adenosine to the XR patient 158, as well as the possible effects as defined by the associated effect and timer nodes 1371C, 1371E.

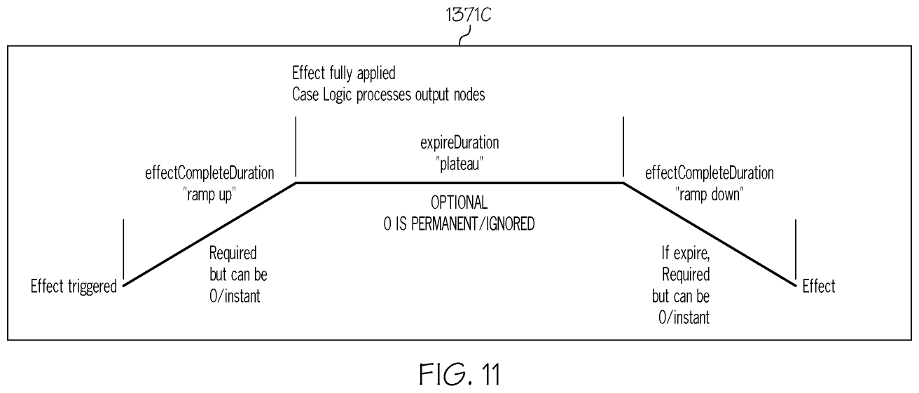

Referring next to FIG. 11, further details on the case logic module 135 processing flow and operations of the system 100 to provide functionality in accordance with the present disclosure are shown. In particular, an application of these parameters is depicted for an example effect node 1371C. As shown, one or more of the parameters may be read from the case logic module 135 such that the resulting impact may be applied or tracked according to the expireDuration parameter (as a plateau) and the effectCompleteDuration parameter (as ramp-ups and ramp-downs). In one form, the effectCompleteDuration parameter, which represents the time for the effect to be fully applied, is optional. In the event of its usage, a value set to zero for the effectCompleteDuration parameter means instant, while an effectCompleteDuration parameter value of greater than zero will add a timed amount to ramp up the effect. When the duration reaches zero, the case logic module 135 will resume processing of the outputs of the effect node 1371C, and an optional expireTimer parameter (not shown) may begin. Likewise, a zero value for the expireDuration parameter means permanent, while an expireDuration parameter value of greater than zero will add a timed amount to plateau the effect, and when its duration reaches zero, the effectCompleteDuration parameter will be used again to ramp down the effect, and once fully ramped down, the effect removed.

As discussed elsewhere, the timer node 1371E may be made to begin on the start of a case, or as a triggered effect node 1371C in the case logic module 135. The timer node 1371E serves also as a continuation point for the case logic module 135. In the rapid case creation tool 145, if a displayed timer node 1371E does not have a connection (interconnection 1373) from the left side, it is an “initial timer”. These will start counting down when the game becomes active. If the node does have a connection from the left side, it is an “effect timer”. These will start counting down when the previous node output triggers into the timer. Effects with an effectCompleteDuration parameter 201B that is greater than zero, an expireDuration parameter 201A that is greater than zero, or an absoluteVitalDelay parameter (not shown) that is greater than zero can also create timers. It is to be appreciated that placement of the data nodes 1371 within the logic design window 1370 of FIG. 8 and that is part of the case creation tool 145 does not need to be in any particular order to make the interconnection 1373.

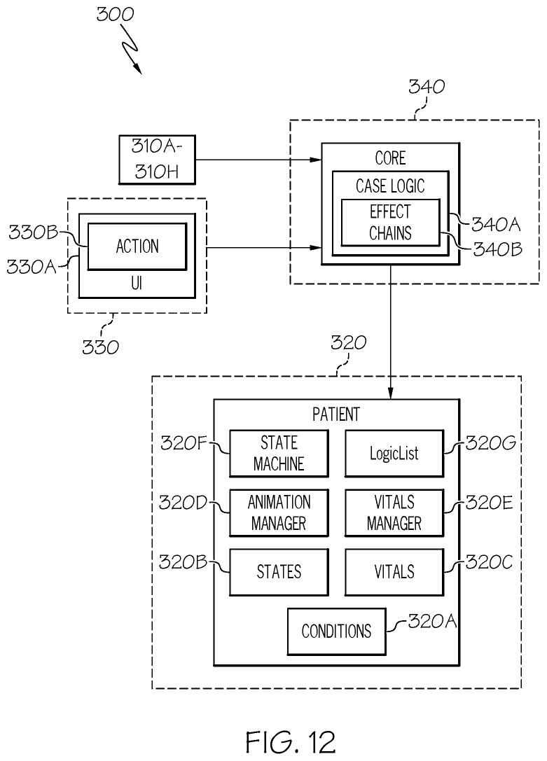

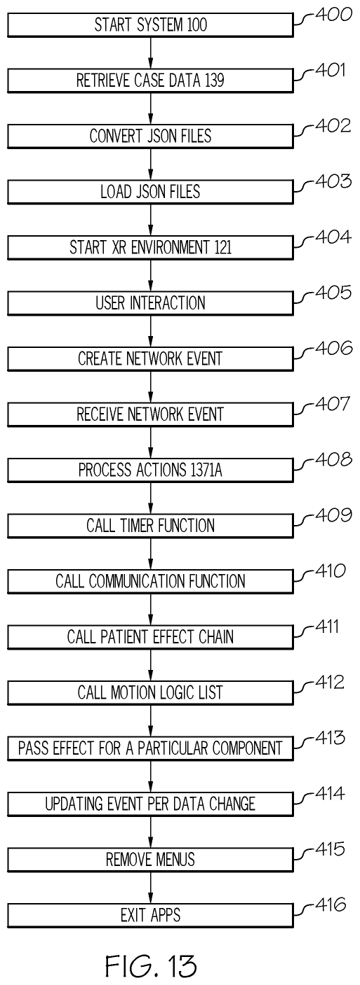

Referring next to FIGS. 12 and 13 in conjunction with FIGS. 7 through 10, a high-level flow diagram (FIG. 12) and a more detailed flow diagram (FIG. 13) showing various an ordered sequence of steps associated with starting a training exercise for the XR patient 158 are described. In this way, the flow diagrams illustrate in a procedural way program structure that is executed by the system 100 in order to implement one or more aspects of the disclosure. In one possible implementation, the high-level flow of FIG. 12 is shown for an XR patient using the system of FIG. 1.

Referring with particularity to FIG. 12, the high-level flow 300 shows the interaction between various components, modules, managers or the like in the form of four major groups: (i) a simulation manager group 310, (ii) a patient manager group 320, (iii) an actions manager group 330 and (iv) a core manager group 340. In general, the simulation manager group 310 includes various infrastructure-related activities and setups, including for voice-over-internet-protocol (VOIP) 310A, network manager 310B, audio manager 310C, settings 310D, game manager 310E, game timer manager 310F (which in one form may be used to control the previously-discussed timer node 1371E), reference (that is to say, events) manager 310G and environmental spawn manager 310H. The patient manager group 320 includes conditions 320A, states 320B (which in one form may be used to control the previously-discussed patient states 1390L, custom states 1390N, animation repeat states 1390Q, animation states 1390R or mental states 1390S), vitals 320C (which in one form may be used to control the previously-discussed vitals 1390A), animation manager 320D (which in one form may be used to control the previously-discussed patient animation manager 1390K), vitals manager 320E, state machine 320F and LogicList 320G.

The actions group 330 may include a UI 330A for access to settings, controllers, voice commands and the simulated tools (such as the previously-discussed stethoscope, penlight or the like); all of these may be used to feed into the user action 330B (which in one form may be used to control the previously-discussed actions 1371A of FIGS. 8 through 10) into the core manager group 340 where the information pertaining to case logic 340A (which in one form may be retrieved from the case logic module 135 of FIG. 6, and which may include the web service and physiological model the latter of which is depicted in the effects chain node 1371D) may be used in the core 340C in conjunction with the JSON-adapted incoming data from the data case module 139 in order to create an interactive, dynamic training simulation. It will be appreciated that these lists are merely representative rather than exhaustive, and that greater or fewer numbers of elements within one or all of these four groups may be included. In general, the infrastructure-related activities and setups 310A through 310H that make up the simulation manager group 310 may be formed from conventional descriptions of the underlying activity or setup. In general, FIG. 12 depicts how one or more of the infrastructure-related activities and setups 310A through 310H (such as timer 310F) and a UI form the actions manager group 330 could trigger the case logic 340A from the core manager group 340 to run, which would then have an impact on the state of the case and the XR patient 158. In this way, it most closely matches the portion of FIG. 6 that corresponds to the timer/action→check (statement)→effect. The logicList 320G of FIG. 12 is used to hold those timer/action/check/effect/effectChain data objects in the simulation.

Referring with particularity to FIG. 13, various steps used to set up a training exercise for the XR patient 158 is described as follows. First, in step 400, a student (user) starts up the system 100 using a UI form the actions manager group 330 that in one form is part of the I/O unit 140. If offline, the student selects an XRPC and automatically joins an offline lobby. If online, the student can start an online lobby and select an XRPC, or join an existing lobby for an already-running XRPC. Second, in step 401, the case data for the XRPC is retrieved from the database 150 in a JSON file such as those discussed in conjunction with the data case module 139. In one form, this has keys reflecting various medical or patient-related values including a content management system (CMS) and case logic medical value overrides. In one form, these values correspond to an enumeration type keyword (enum, such as depicted in FIG. 4) that may declare various integer constants within certain programming languages (such as the aforementioned C#, C++, R or the like). Third, in step 402, the XR application (such as the previously-mentioned Unity Virtual Reality application) that is running on the controller 110 acts as an adaptor to convert the JSON file into data objects containing various enumerated values, including those for initial vitals, states and conditions, case logic and effects chains. Next, in step 403, any additional information that needs to load based on the data received in the JSON file is loaded, after which a start button (not shown) appears active on the XR display 120. Lastly, the user then clicks the start button that appears on the I/O unit 140; this in turn causes any participating student or students to be teleported to the XR environment 121. A game timer (not shown) is started once the teleport operation is complete. Any preset action and timer nodes 1371A, 1371E are also started at this time.

Once the training exercise has been set up, steps associated with the use of the started training exercise are followed. As a threshold matter, if at any point during the exercise the timer reaches zero or the XR patient 158 is deemed to have “died”, a fail event is called, which has the effect of disabling any timers and any further input. All action and completed events are sent across the network through the network manager 310B and put in queue in a network instigator buffer (not shown) so they can be processed in the appropriate order. Any timestamp differences due to lag are reconciled and passed throughout case logic module 135 until they are fully accounted for. First, in step 405, a student interacts with a menu in the UI; this has the effect of having the student interact with a virtual object in XR environment 121 while the case logic from the case logic module 135 of another user (such as an instructor) includes an initial timer (that is to say, a timer node 1371E but that is not related to any predecessor nodes) that is set to zero and that has the effect of doing the same to the student user's timer. Next in step 406, the action or timer nodes 1371A, 1371E create a network event in the network manager 310B and calls the function NetworkRequestPatientAction (CustomEventCode, patientIndex, object[ ]) to request that an action be taken via the action node 1371A, while the function NetworkLogicTimerComplete (historyOutputTime, key) is taken via the timer node 1371E. The timestamp for any action, as well as any of a complete event time from timer node 1371E, are compared within the network manager 310B upon receipt, and if a timestamp is prior to the last received timestamp, that timestamp is pushed forward to the last timestamp received plus 1 millisecond as part of a type punning approach to ensure that the chronology matches the receipt order in order to be consistent with the programming language's type system. Each timer node 1371E has a key such that the data is created and stored locally and is passed from all users, although only the first one received will be used to unlock and retrieve its local case logic data. In essence, the code may handle multiple different clients handling a timer event in a reliable and decentralized fashion. In this way, each client will store the same data and send the exact same message out over the network, even though the certainty of when a particular client's message is received might not be initially ascertainable; in this way, the system 100 may handle the first message and ignore the rest. The reason its doing all of that over the network instead of just processing it locally on each client is so that the timer event is in proper chronological order with whatever user actions might be taking place over the network. In such case, the key needs to be consistently unique across all of the users. The key format is: TTTTTTTCCCEEEELLLL (one digit unused, followed by a seven digit timestamp “T”, a three digit timestamp count “C” and an eight digit node identification where the first four are the effect chain's internal node's identification “E” and the second four are the case logic's node identification “L”). Next, in step 407, the network event is received by the user and put into the network instigator buffer so it can be processed in the appropriate order by the case logic 340A from the core manager group 340. Within the present context, the case logic 340 of FIG. 12 is a high-level view representing the ACE data objects and data, whereas the case logic module 135 of FIG. 6 is the low level view of the data objects and data elements or data values. Any timestamp differences due to lag are reconciled and passed throughout case logic module 135 until they are fully accounted for by the controller 110. Next, in step 408, if there is an identifiable action (such as one or more of actions 1371A), the case logic 340A is called into the appropriate processing function for that action type with the appropriate action type objects. The action types process methods within the case logic 340A were identified as part of the patient actions history action 1391H that is depicted in FIG. 5 and include:
ProcessAssessmentAction(patient, . . . );
ProcessProcedureAction(patient, . . . );
ProcessOxygenAction(patient, . . . );
ProcessLeadsAction(patient, . . . );
ProcessPacingAction(patient, . . . );
ProcessQuestionAction(patient, . . . );
ProcessMedicationAction(patient, . . . );
ProcessLabAssetOrdered(patient, . . . );
ProcessLabAssetViewed(patient, . . . );
ProcessLabResultOrdered(patient, . . . );
ProcessLabResultViewed(patient, . . . );
ProcessCompressionAction(patient, . . . );
ProcessIvAction(patient, . . . ); and
ProcessVitalAction(patient, . . . ).

The foregoing represent specific code functions that would be called when a user's input is identified. For example, if a user clicks the menu to insert an IV, ProcessIvAction(patient, . . . ) would be called in order to pass the corresponding input as parameters. The case logic 340A process is then run with the input compared to the case logic data to determine what would change in the simulation. It is understood that each of the functions correspond to the list of actions previously identified in conjunction with FIG. 5.

The actions, checks, effects and effect chains that are associated with the chosen action are passed into the logic list 320G (which in one form may be embodied by logic list 135N of the case logic module of FIG. 6). Next, in step 409, if the timer node 1371E is being used, the case logic manager function HandleTimerComplete(Timer, LogicList) is called for use when a timer finishes. Subsequently, the HandleTimerComplete(Timer, LogicList) function may be called in order to have the timer and logicList passed as parameters. The case logic process is then run with the case logic data to determine what would change in the simulation. In this case, the checks, effect chains and effects attached to the timer 1371E are passed into the logic list 320G. If from within an effect chain, they are passed into a standalone logic list. In essence, the XR patient 158 has a logicList which is the primary logicList and is what holds the case logic nodes that need to be run. Secondary versions of such logicList get made for timers and effect chains, which are temporary. Since timers don't run until the timer completes, a temporary logicList is created to store the timer's case logic nodes on the temporary logicList until the timer finishes. Likewise, since the effect chains have their own sub-logic that must be completed before continuing with the effect chains follow up nodes, a temporary logicList is created to the effect chain's case logic nodes on the temporary logicList to be processed until it until finishes. Once those secondary logicLists finish-either from the timer finishing or the effect chain's case logic nodes finishing-their outbound case logic nodes are added to the primary logicList, after which the temporary logicLists are destroyed. From there, the primary logicList processed to completion. Next, in step 410, the function CaseLogicManager.ProcessChecks(patient, patient.logicList) is called. This has the effect of evaluating the checks (such as the check nodes 1371B) where any resulting effect chains and effects are added to the logic list. In one form, the checks might utilize a field named isCumulative in order to determine whether the check looks at the current/last value (false) or the combined value of all previous items (true) where the default is the current or last value. For example, if the check corresponds to the medication Ibuprofen being administered as an oral dose in the amount of 200 mg, a current check of the last dose given versus an aggregate check such as the medication Ibuprofen oral dose of 600 mg cumulative check over the whole case may be shown. It is to be noted that if a timer is used prior to this type of check, it's possible to have a different action of that type inadvertently “sneak in” before the check is reached than the one that instigated the case logic. In such case, a warning is to be displayed in the rapid case creation tool 145 and may be sent to the instructor. Next, in step 411, the logic list effect chain of the XR patient 158 is processed by calling the function ProcessEffectChains(patient) that is contained in the logic case manager 135A of the case logic module 135. The effect chain's internal connections are added to a standalone logic list and the isEffectChain that is contained in the logic list 135N of the case logic module 135 and set to a Boolean “true” value. The newly created standalone LogicList is used to call ProcessChecks(patient, LogicList) that is contained in the logic case manager 135A of the case logic module 135. Any checks are evaluated further, while any effects are added to the standalone logicList which is then passed to ProcessEffects(patient, LogicList) entry within the logic case manager 135A of the case logic module 135. The effects are processed and if there are any effectCompleteDuration timers (as noted in the effect portion 135L of the case logic module 135), the effect chain will remain active until all timers are completed. Once completed, the effect chain's potential exitChecks, exitEffects and exitEffectChains (as noted in the effect portion 135L of the case logic module 135) will be added to the patient logicList 320G and its processing will continue back at ProcessChecks of FIG. 6. Next in step 412, the function ProcessEffects(patient, patient.logicList) that is contained within the logic case manager 135A of the case logic module 135 is called such that the logic list of the XR patient 158 is used. The list is scanned for an end effect, and if found, the “win” event is called, disabling any timers and additional input, whereas if it is not found, the effects are sent so that any triggered effect that has an effectCompleteDuration will have a timer created with the effect's resulting checks and effects. Next in step 413, the effect for the case and that particular component (by way of example, PatientVitalsManager for vitals and PatientAnimationManager for animations, both as depicted in the effect portion 135L of the case logic module 135), as well as the patient data 139F of the case data module 139 of FIG. 3) are passed. From there, any modifications that may exist are made, while any effect expireDuration timers may be started, and any updates to vitals, conditions, and states data are also made. Likewise, an event for each type of data change may be made, as depicted generally in FIG. 12. Next, in step 414, event listeners belonging to the various objects are each responsible for updating based on the latest vitals, conditions and states data.

Once the training exercise has been run, steps associated with ending a training exercise for the XR patient 158 are performed. In step 415, when the training session wraps up, the XR patient (or patients) 158 and menus disappear from the user's XR display 120. At this time, all student actions are displayed in a debriefing menu (not shown) with the appropriate messaging (such as “win”, “fail” or something comparable). In step 416, the student may click a button (such as a Return To Dispatch Exit Case button, not shown); this has the effect of teleporting the student or students back to the dispatch area, as well as unloading any extra scenes. At his time, any remaining case data is reset and the process may be repeated for a next case. It will be appreciated that although for the sake of brevity only certain exemplary function calls are shown, the present disclosure is not so limited. As such, the various function calls that correspond to any or all of the actions, check, effects or the like are understood to be within the scope of the present disclosure.

It is noted that, in some implementations, the XR environment 121 may be available in situations in which disparate users may participate. For example, a particular XRPC may allow two or more users to participate in a multiplayer mode. In addition, modifications of the case logic module 135 for a particular XRPC may be made such that a skill level of the user(s) is taken into account. Thus, where a user is inexperienced or is having a difficult time with an XRPC, the case logic module 135 may be customized accordingly to ensure the user is progressing in their learning of the stated objectives for the reduced-complexity version of the XRPC. As will be appreciated, a system implemented in this way can provide consistent, objective grading in an industry that is currently largely subjectively graded across different skill levels.

In one form, details associated with the XR patient 158 within a particular case may correspond to activities and setups for beds, IVs, clothing, moulage (or related mock injuries or maladies), a three-dimensional patient mesh (that is to say, the representation of the XR patient 158), conditions, states, vitals, monitors, authoring tool, UI, voice commands, stethoscope, penlight and animator mechanism. Although not shown by arrows, it is understood that connectivity between the various blocks depicted as patient manager group 320, actions manager group 330 and core manager group 340 may be present in order to have moulage, sounds, clothing or the like, as these things are (or can be) customizable.

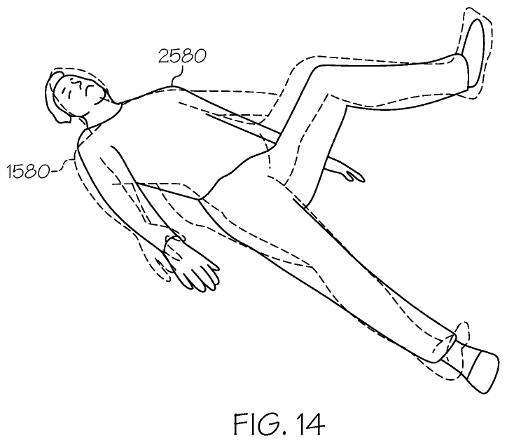

Referring next to FIG. 14, in one form, an overlay 1580 may be placed over a mannequin 2580 that is used to represent the XR patient 158 for subsequent image generation on the XR display 120. In one form, such an overlay 1580 may be used to simulate wounds, missing limbs and other conditions, as well as present optional dialogue between the user and the XR patient 158. Various caregiver interactions may be presented, including those associated with CPR, needle decompression, tourniquets, chest seals (of which halo is one example) for bullet holes and related punctures in the chest, packing wounds or the like. In one form, a motion used for hand-swiping for blood may be employed as an example of a real-world-to-virtual-integration. In one form, such motion may include running the hands along the back and under armpit and subsequent viewing of the hands to detect for the presence of blood. In one form, the image formed by the overlay 1580 may define varying degrees of opacity or transparency such that when placed in conjunction with the mannequin promotes improved depth perception and context-awareness to the user, such as through changes in scale, transparency or the like.

Those skilled in the related art would further appreciate that the various illustrative logical blocks, modules, circuits and algorithm steps described in connection with the disclosure may be implemented as electronic hardware, computer software or combinations of both. To clearly illustrate this interchangeability of hardware and software, various illustrative components, blocks, modules, circuits and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods or interactions that are described herein are merely examples and that the components, methods or interactions of the various aspects of the present disclosure may be combined or performed in ways other than those illustrated and described herein.

Functional blocks and modules in the drawings may comprise processors, electronics devices, hardware devices, electronics components, logical circuits, memories, software codes, firmware codes or any combination thereof. Consistent with the foregoing, various illustrative logical blocks, modules, and circuits described in connection with the disclosure herein may be implemented or performed with the processor 111 (as depicted in FIG. 1) that may be formed as a general-purpose processor, a digital signal processor (DSP), an application-specific integrated circuit (ASIC), an application-specific standard product (ASSP), a field-programmable gate array (FPGA) or other programmable logic device, discrete gate or transistor logic, discrete hardware components or any combination thereof designed to perform the functions described herein. The processor 111 may be a microprocessor, a plurality of microprocessors, microcontroller or state machine. The processor 111 may also be implemented as a combination of computing devices, such as a combination of a DSP and one or more microprocessors or any other combination. In system configurations where numerous processors 111 are used, it will be appreciated that each processor 111 may implement the same or different instruction set architectures (ISAs). The processor 111 may comprise code segments (including one or more of software, firmware and hardware logic) executable in hardware to perform the tasks and functions described herein. In yet other aspects, processor 111 may be implemented as a combination of hardware and software. The processor 111 may be configured to run on numerous operating systems, including conventional ones such as Windows, MacOS, Android or the like.

An exemplary form of the memory 112 is either coupled to or integral with the processor 111 such that the processor 111 can read information from, and write information to, the memory 112, as well as operate upon instructions that, when executed by the processor 111, cause the processor 111 to perform operations, such as part of the aforementioned ASIC which in turn may reside in a user terminal, base station, sensor or any other communication device. In the alternative, the processor 111 and the memory 112 may reside as discrete components in a user terminal. As discussed elsewhere, the memory 112 may be either cooperative with or part of the database 150.

In situations where the method or algorithm is at least partially embodied in a software module, the module may reside in memory 112 or related computer-readable media and that can exist in the form of random access memory (RAM), flash memory, read-only memory (ROM), EPROM memory, EEPROM memory, registers, hard disk, removable disk, CD-ROM, solid state drives (SSDs), non-transitory computer readable medium or any other form of storage medium configured to store data in a persistent or non-persistent state as known in the art. Regardless of its form, the memory 112 may be configured to store program instructions, including parts thereof in the form of machine code or related executable program elements that implement the desired steps of a method or algorithm consistent with a given case. Within the present disclosure, the machine code forms one or more pieces of program structure that may be arranged as a set or related ordered sequence (such as depicted graphically in FIGS. 8 through 10 or procedurally (such as depicted in FIGS. 12 and 13) capable of operating upon particular pieces of data structure (which may, for example, be in the form of numeric values organized as trees, graphs, link lists, arrays, records, classes, unions or the like). As such, the data elements that are associated with one or more of the modules 135 and 139 and that may be storable in the database 150 (which may the same as or otherwise cooperative with memory 112) may be implemented as data structures. In one form, any such function-related logic may be implemented in one or more threads. Likewise, the modules and data structures may also be transmitted as generated data signals that are part of a carrier wave or other analog or digitally-propagated signal. In this way, one or both of the wired and wireless transmission approaches may qualify as the previously-discussed computer-readable media. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of such medium. As such, the processor 111 may comprise or otherwise be cooperative with memory 112 for storing and operating upon such program instructions that-when put into an executable form as machine code can be understood by the processor 111. As disclosed herein, such machine code may be in the form of application software or operating system software, depending upon whether it is acting in its capacity as an interface between the user and the system hardware or between the system hardware and the underlying operating system.

The combination of structural and functional features of various components and corresponding case software in order to produce a relationship necessary to constrain implementation of the system 100 is described in more detail as follows. In one form, the software provides functional attributes in the form of instructions to the system 100 such that the structural attributes that are provided by the hardware of the processor 111—which is preconfigured to interpret executable forms of such instructions by virtue of its particular ISA—impart specific meaning to such instructions. As will be understood, this ISA is responsible for organization of memory and registers, data structures and types, what operations are to be specified, modes of addressing instructions and data items, as well as instruction encoding and formatting. Thus, the ISA acts as an interface between the purely structural attributes of the processor 111 and the functional attributes of the system or application software through the implementation of ISA-specific machine code. It is this interrelationship that constrains the way in which the processor 111 is controlled in order to achieve the desired functionality. In one form, the software includes application software and system software where the former acts as an interface between the user and the latter, while the latter acts as an interface between the former and the computer hardware of system 100.

More particularly, the interrelationship between the system software and the hardware is established by virtue of a native instruction set that in turn is made up of an executable form of the system software under the particular ISA of the processor 111 and ancillary components within system 100. This platform-specific native instruction set includes executable program element portions that make up machine code or machine code sets that in turn allows the processor 111 to become particularly configured to perform a predefined set of operations in response to receiving a corresponding instruction from a separate set of machine codes, such as those associated with the application software and that are configured effect the logic of a particular XRPC.

In a generally similar way, the application software that becomes a corresponding piece of machine code is predefined to perform a specific task; one or more such pieces may be arranged as a larger machine code set in order to achieve the functionality set forth in one or more steps that are associated with a particular case. In this way, source code created by a programmer (such as that corresponding to the data, states, actions, effects and other logic of FIGS. 3 through 6) may be converted into executable form and structurally stored as machine code that may be part of a shared library or related non-volatile memory that is specific to the implementation of the processor 111 and its particular ISA. From this, the machine code may be arranged in a particular way by a user in order to perform the functionality of a particular case or related training scenario. By way of example, a set of machine codes may be made to correspond to user actions, while another may be made to correspond to checks, another to effects upon the XR patient 158, and still another on an effect chain. It will be appreciated that what makes up a set of machine codes may be grouped differently, such as through the interconnection of various nodes or the like, and that regardless of the way the machine codes are grouped in order to achieve the functionality associated with a given case, they all are within the scope of the present disclosure.

Significantly, the machine code, native instruction set and other portions of executable program instructions are understood as a physical manifestation of their underlying logic or data and as such become structural elements within the system 100 in much that same way as the processor 111, memory 112 and other components (such as those depicted in FIG. 1); these in turn may cooperate within a particular XRPC or related training scenario to produce the case setup, building and modifying functionality disclosed herein. Moreover, the particular pieces of data structure (such as stored within the database 150 in one or more of the previously-disclosed trees, graphs, link lists, arrays or related forms) may be operated upon by the one or more pieces of the program structure in order to achieve the case operational functionality for user training and education as disclosed herein.

In one form, the I/O 140 may be configured to coordinate I/O traffic between processor 111, memory 112 and any peripherals in the system 100, and may include performing any necessary protocol, timing or other data transformations to convert data signals from one component (such as memory 112) into a format suitable for use by another component (such as the processor 111), as well as support for devices attached through various types of peripheral buses, such as the Universal Serial Bus (USB) or the Peripheral Component Interconnect (PCI) bus standard. In one form, some or all of the functionality of I/O 140 may be incorporated directly into processor 111. In one form, the I/O 140 may be configured to allow data to be exchanged between the system 100 and other device or devices attached to a network or networks. In one form, the I/O 140 may support communication via any suitable wired or wireless general data networks, such as types of Ethernet networks, wireless networks or the like.

Within the present disclosure, the terms used to identify the various modules (such as the case logic module 135 and the case data module 139) all recite (in the form of compound nouns) self-sufficient pieces of structure that are identified by the function they perform. In this way, these term to have a sufficiently definite meaning as the name for the module as structure is identified within the context of the corresponding function. In this way, the elements that make up these modules—regardless of being in the form of various computer software, firmware and hardware features—are described structurally to provide a tangible, definite interface between the user, the software and the computer hardware of the system 100 as a way to provide the functionality as discussed herein.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Within the present disclosure, the use of the prepositional phrase “at least one of” is deemed to be an open-ended expression that has both conjunctive and disjunctive attributes. For example, a claim that states “at least one of A, B and C” (where A, B and C are definite or indefinite articles that are the referents of the prepositional phrase) means A alone, B alone, C alone, A and B together, A and C together, B and C together, or A, B and C together. By way of example within the present context, if a claim recites that the wound irrigation treatment system may selectively adjust at least one of an amount of irrigation fluid and an amount of excess fluid, and if such adjustment is the addition or removal of one or both of the irrigation and excess fluids, then such data acquisition satisfies the claim.

Within the present disclosure, the following claims are not written in means-plus-function format and are not intended to be interpreted based on 35 USC 112(f) unless and until such claim limitations expressly use the phrase “means for” followed by a statement of function void of further structure.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A customizable extended reality patient simulator system comprising:
a controller configured to operate upon executable program elements that are in the form of case-specific information pertaining to an extended reality environment and case-specific interactions between a user of the system and an extended reality patient;
a display signally cooperative with the controller and configured to depict to the user the extended reality environment with the extended reality patient situated therein;
a plurality of sensors signally cooperative with the controller;
a feedback unit signally cooperative with the controller, the display and the plurality of sensors to present to the user a sensory-based immersion within the extended reality environment; and
a rapid case creation tool formed on the display to provide a graphical representation of at least a portion of the executable program elements to the user, the rapid case creation tool comprising:
a case data module; and
a case logic module cooperative with the case data module such that upon manipulation by the user of at least a portion of the graphical representation of the executable program elements from each of the case logic module and the case data module, the system performs at least one of:
creation of an extended reality patient case;
modification of the extended reality patient case; and
operation of the extended reality patient case.

2. The customizable extended reality patient simulator system of claim 1, wherein the controller comprises at least one processor and memory cooperative with one another to respectively operate upon and store the machine code.

3. The customizable extended reality patient simulator system of claim 1, wherein the graphical representation comprises a logic design window configured to display editable case nodes that are selected from the case logic module.

4. The customizable extended reality patient simulator system of claim 3, wherein the editable case nodes comprise actions, checks, effects and effect chains.

5. The customizable extended reality patient simulator system of claim 4, wherein the editable case nodes further comprise a timer node.

6. The customizable extended reality patient simulator system of claim 4, wherein the actions comprise at least one of conducting an assessment, administering medication, placing an intravenous line, placing at least one lead, performing a compression, checking vital signs, reviewing orders and reviewing laboratory results.

7. The customizable extended reality patient simulator system of claim 4, wherein the logic design window is further configured to display interconnection lines that upon placement between a pair of the editable case nodes establishes a logical connection therebetween.

8. The customizable extended reality patient simulator system of claim 1, wherein the graphical representation comprises a plurality of sub-modules of the case data module, the sub-modules comprising a state sub-module and an actions sub-module.

9. The customizable extended reality patient simulator system of claim 1, further comprising an overlay that upon use superimposes a visual grid pattern on the extended reality patient within the extended reality environment.

10. A method of operating a customizable extended reality patient simulator system, the method comprising:
retrieving case data for an extended reality patient from a database;
converting the case data into data objects containing values corresponding to at least one of initial vitals, initial states, initial conditions, environments, placements, patient and case logic that includes effect chains;
upon user interaction with a menu within a user interface to ascertain a virtual object in the extended reality environment while the case logic from a case logic module, having an initial timer commence counting;
having at least one of an action or timer event create a network event in a network manager such that it calls at least one function;
presenting the network event to the user;
determining if there is an identifiable action such that if so, the case logic is called into the appropriate processing function for that action type with the appropriate action type objects;
evaluating at least one check and adding any resulting effect and effect chain to a logic list;
processing the logic list effect chain by calling a function;
calling a function and scanning it for an end effect such that if found, a “win” event is called such that any timers and additional input is disabled, whereas if it is not found, the effects are sent so that any triggered effect will have a timer created with the effect's resulting checks and effects;
passing the effect for the case along with its corresponding component, along with the patient data; and
updating event listeners corresponding to updates ones of the data objects of respective vitals, conditions and states.

11. The method of claim 10, wherein the presenting the network event to the user comprises putting the presented into the network instigator buffer so it can be processed in order by the case logic from the core manager group.

12. The method of claim 10, wherein if the timer is being used, a case logic manager function configured to handle a Handle TimerComplete function is called;

13. The method of claim 10, wherein evaluating at least one check and adding any resulting effect and effect chain to a logic list is performed through CaseLogicManager, ProcessChecks(patient, patient.logicList) function.

14. The method of claim 10, wherein the function called for processing the logic list effect comprises a ProcessEffectChains(patient) function that is contained in a logic case manager that forms part of the case logic module.

15. The method of claim 14, wherein internal connections of the effect chain are added to a standalone logic list and set to a Boolean “true” value.

16. The method of claim 10, wherein the function called and scanned for the end effect comprises ProcessEffects(patient, patient.logicList) function.

17. The method of claim 10, wherein passing the effect for the case and its corresponding component comprises at least one of a PatientVitalsManager function for vitals and a PatientAnimationManager function for animations.
